(19) United States
(12) Patent Application Publication
(10) Pub. No.: US 2005/0013021 A1
(43) Pub. Date: Jan. 20, 2005

(54) Decentered optical system, light transmitting device, light receiving device, and optical system

(75) Inventors: Koichi Takahashi, Tokyo (JP); Junko Takahashi, Sagamihara-shi (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/862,908

(22) Filed: Jun. 8, 2004

(30) Foreign Application Priority Data
Jun. 10, 2003 (JP) 2003-165372
Jul. 4, 2003 (JP) 2003-271156

(51) Int. Cl. G02B 17/00

(52) U.S. Cl. 359/837

(57) ABSTRACT

The decentered optical system is configured by a first, a second and a third reflecting mirror disposed decentered, a focusing device, and a light receiver. The optical path is folded by the first, second, and third reflecting mirrors, aberration correction is carried out by a rotationally asymmetric reflecting surface, and an intermediate image is formed between the second and third reflecting mirrors and another reflecting mirror. The reflected light of the third reflecting mirror is made to form a substantially parallel light beam that forms an exit pupil. An image is formed on the light receiving surface by the focusing device. This decentered optical system is used in a light transmitting device, a light receiving device, and a light transmitting and receiving system, and carries out light tracking by detecting the position of the received light image.

### PRIORITY CLAIM

Priority is claimed on Japanese Patent Application Nos. 2003-165372 filed Jun. 10, 2003, and 2003-271156 filed Jul. 4, 2003.

### BACKGROUND OF THE INVENTION

1. Field of the Invention

The present invention relates to a decentered optical system, an light transmitting device, a light receiving device, and an optical system, and in particular, relates to a decentered optical system, an light transmitting device, an light receiving device, and an optical system that can by advantageously used when carrying out focusing on a focal plane.

2. Description of the Related Art

Conventionally, it is known that a catoptric system has superior properties in comparison to a dioptric system depending on the field of application.

The advantages of a catoptric system are that: because chromatic aberration does not occur, an extremely wide band can be covered if the catoptric system consists of reflecting materials and reflecting films that allow reflection spectral characteristics; optical paths can be folded easily and thereby form an optical system that is compact as a whole; and the curvature can be made small because, for the same curvature, the power is four times that of a refracting interface, and thereby the occurrence of aberration can be suppressed.

In fields like astronomy, there are, for example, the well-known Cassegrainian and Gregorian catoptric systems that use a combination of primary mirror and secondary mirror. However, because these mirrors are disposed coaxially, the secondary mirror portion is obstructed and optical loss occurs.

In order to improve this characteristic, a variety of catoptric systems have been proposed. These are a type of decentered optical system in which a plurality of refracting surfaces is combined so as to be decentered and tilted with respect to each other.

For example, citation 1 (Japanese Unexamined Patent Application, First Publication No. 7-146442; pages 2 to 5, and FIG. 2) discloses a catoptric system that is formed by three reflecting surfaces. The three reflecting surfaces, disposed in sequence from the objective side, consist of a concave reflecting surface, convex reflecting surface, and concave reflecting surface. When their respective paraxial radii of curvature are denoted by r₁, r₂, and r₃, then:
0.9<r₂/r₁+r₂/r₃<1.1

In addition, citation 2 (Japanese Unexamined Patent Application, First Publication No. 2000-199852; pages 2 to 6, and FIGS. 1 and 4) discloses a catoptric system wherein an afocal optical system is formed by disposing off-axis from the object side a first concave mirror having a positive power and a convex mirror having a negative power, further disposing a second concave mirror having a positive power, and these three surface shapes are made aspheric and disposed off-axis.

Citations 3 and 4 (U.S. Pat. No. 4,265,510, FIGS. 1 and 3; U.S. Pat. No. 4,834,517, FIGS. 2, 4, and 6) disclose an optical system formed by three mirrors having respectively positive, negative, and positive powers decentered and tilted with respect to each other. In addition, these mirrors form an intermediate image once within the optical system and form an exit pupil in proximity to the image plane. At the same time, the light rays are formed into convergent light in the vicinity of the position of the exit pupil.

Citation 5 (Japanese Unexamined Patent Application, First Publication No. 3,177,118, pages 2 and 3, and FIG. 2) discloses an optical system formed by three mirrors decentered and tilted with respect to each other, and consisting of positive, negative, and positive power mirrors, and a corrected mirror that is substantially non-magnifying.

These decentered optical systems are used as light transmitting devices, light receiving devices, and optical systems.

In the technology described in citation 1, the concave reflecting surface, the convex reflecting surface, and the concave reflecting surface each form a coaxial optical system having a rotationally symmetric aspheric surface, and the light beam from the object progresses by being folded between the three coaxially related reflecting surfaces. Therefore, in order to establish a larger incident light beam diameter, the convex surface must be made small so that the incident light beam that is first incident on the convex reflecting surface is not blocked by the convex reflecting surface, and thus it is necessary to make the radius of curvature of the first concave surface small.

In addition, although in this configuration the three reflecting surfaces are disposed in a coaxial relationship and this configuration has a small image plane curvature, this can be considered to be substantially equivalent to a decentered reflecting surface when considered in terms of the optical axis reference because only one surface of each of the two concave reflecting surfaces with respect to the optical axis is used.

In the technology disclosed in citation 2, the light beam that has passed through the entrance pupil is reflected at the first convex mirror, subsequently becomes a light beam having an angle of divergence that is a power of two with respect to the incident angle, and then guided to the image side.

In the technology disclosed in citations 3 to 5, a configuration is used wherein an intermediate image is relayed and then an image formed, but because the light beam incident on the exit pupil becomes convergent light, the pupil position becomes separated from the mirror, and becomes close to the final image position. Therefore, the position of the exit pupil is in proximity to the image plane and the second mirror. As a result, in the case, for example, that an optical element such as a reflecting mirror is disposed at the exit pupil position, the light beam is obstructed easily due, for example, to manufacturing errors or installation errors.

### SUMMARY OF THE INVENTION

In a first aspect, the present invention is a decentered optical system that uses a substantially parallel light beam as the input light, and is characterized in comprising in order along the optical path of the input light a positive power first optical element having positive power, a second optical element having a rotationally asymmetric decentered reflecting surface that is positioned decentered from or tilted on the optical axis of the input light, and a third optical element forming an optically active surface having a positive power, and further, an intermediate image is formed by these first and second elements and an exit pupil is formed by the first through third optical elements, a focusing device that focuses the light beam that has passed through the exit pupil on at least one light receiving plane, whereby the angle formed between a principal ray and a subsidiary (characteristic) ray of the axial light beam incident on the exit pupil is almost parallel.

According to the present invention, because the second optical element is a decentered reflecting surface that is decentered and tilted, it is possible to make a decentered optical system having a configuration wherein the light beam is not blocked by the optical elements, and thus light loss does not occur. In addition, because the second optical element is formed as a reflecting surface, the light beam can be folded, and thus it becomes possible to make the device as a whole compact. In addition, because chromatic aberration does not occur at the reflecting surface, it is possible to improve the image forming capacity. In particular, in the case that the optical system is configured entirely by optically active surfaces, it is possible to make an optical system that has no chromatic aberration at all.

In addition, as described above, in the in-plane that includes the optical axis that is folded such that light loss does not occur, the decentered optical system is configured such that the optical elements are decentered from or tilted on the optical axis. However, because a rotationally asymmetric decentered reflecting surface is provided in the second optical element, it is possible to reduce the manufacturing cost in comparison to the case of providing a rotationally asymmetric surface in the first optical element, and it is possible to balance cost and effect. However, in terms of correcting aberration, it is preferable that the first optical element and the third optical element have rotationally asymmetric surfaces.

Furthermore, because aberration correction is sufficient, it is possible to reduce the number of optical elements in the configuration. In addition, it is possible to form an intermediate image having both favorable corrected off-axis aberration and corrected center aberration by using only the first and second optical elements, and thus it is possible to realize an on-axis to off-axis substantially parallel light beam only using the first through third optical elements.

In addition, by configuring the decentered optical system using the first through third optical elements such that the light rays incident on the exit pupil form a substantially parallel light beam that satisfies the conditions described above, this decentered optical system can handle the high performance that is required, for example, for a telescopic photographic optical system and optical communication in space, or optical systems for optical antennas for communication devices that are called “optical wireless”. Concretely, in cases such as a splitting surface being disposed approximately at the pupil position to increase capacity, or aberration correction being carried out by positioning a decentering element such as a galvano-mirror and a position detection element positioned thereafter, or the like, the effective diameter of the subsequent downstream optical elements can be made substantially equal to the exit pupil diameter, and thereby the optical system will be able to handle high performance.

The first optical element can be a transmitting element or a reflecting element. In the case that it is formed by a transmitting element, it is possible to form an optical path length that is comparatively long on the transmitting side of the first optical element, and in the case that it is formed by a reflecting element, it is possible to make a compact configuration because the optical path can be folded.

Because the second optical element is a rotationally asymmetric decentered reflecting surface, it is possible to correct or decrease the aberration caused by decentration by forming the shape of the decentered reflecting surface asymmetrically depending on the amount of decentering of the first optical element.

In particular, the case that the power is negative, it is possible to correct spherical aberration and coma aberration that occur at the first optical element. In addition, because the Petzval sum with respect to the paraxial optical beam is improved, it is possible attain a superior image formation capacity even in the case that the field angle of the incident light beam increases.

In addition, it is possible to form an intermediate image having a superior image forming capacity between the first and third optical elements by providing a negative power at the second optical element to carry out advantageous aberration correction.

Note that in the present specification, an optically active surface denotes a surface on which an appropriate treatment has been applied to the surface, such as the objective surface or the interface of the medium, and seen at a macro level, optical action such as reflection, refraction, interference, polarization or the like is produced. Specifically, persons skilled in the art generally include optical elements having surface shapes such as reflecting surfaces, transmitting surfaces, refracting surfaces, lens surfaces, Fresnel lens surfaces, prism surfaces, filter surfaces, polarizing surfaces, optical surfaces and the like.

In a second aspect of the present invention, the decentered optical system according to the first aspect is configured such that the entrance pupil diameter D, the incident field angle ω₁ of the input light towards the entrance pupil, and the incident field angle ω₂ of the principal ray when the input light is incident on the exit pupil, satisfy the following equation:
0.5 (mm)≦D·(ω₁/ω₂)≦15 (mm) (2)

By satisfying the conditions of equation 2, the incident light beam diameter of the decentered optical system and the angular magnification and exit pupil diameter will fall within an appropriate range.

In a third aspect, the invention is configured such that, in the decentered optical system according to the first aspect, the distance L₁ along the optical axis from the optically active surface of the third optical element nearest the image side to the position of the exit pupil, and the entrance pupil diameter D satisfy the following equation:
0.05≦(L₁/D)≦3 (3)

By satisfying the conditions of equation 3, it is possible to attain an appropriate range for handling high performance by disposing a reflecting surface or the like at the exit pupil without being blocked by the active surface of the third optical element, where this active surface has a positive power.

In a fourth aspect, the present invention is configured such that, in the decentered optical system according to the first aspect, the distance L₂ along the optical axis from the position where the intermediate image is formed to the optically active surface of the third optical element nearest to the object side, and the entrance pupil diameter D satisfy the following equation:
0.03≦(L₂/D)≦1.5 (4)

According to this invention, when the distance L₂ and the entrance pupil diameter D satisfy the conditions of equation 4, the light beam diameter of the parallel light beam formed by the third optical element will fall within an optimal range.

In a fifth aspect, the present invention is configured such that, in the decentered optical system according to the first aspect, the distance L₃ along the optical axis from the decentered reflecting surface of the second optical element to the position where the intermediate image is formed, and the entrance pupil diameter D satisfy the following equation:
0.3≦(L₃/D)≦3 (5)

According to this invention, when the distance L₃ and the entrance pupil diameter D satisfy the conditions of equation 5, advantageous aberration is attained, and the distance from the decentered reflecting surface of the second optical element to the intermediate image will fall within an optimal range.

In a sixth aspect, the invention is configured such that, in the decentered optical system according to the first aspect, the paraxial composite focal distance f₁ between the first optical element and the second optical element and the paraxial focal distance f₂ of the third optical element satisfy the following equation:
4≦(f₁/f₂)≦60 (6)

According to this invention, when the paraxial composite focal distance f₁ and the paraxial focal distance f₂ satisfy the conditions of equation 6, the angular magnification of the optical system up to incidence on the exit pupil, expressed by the ratio f₁/f₂, will fall within an appropriate range. In addition, the light beam diameter of the substantially parallel light beam incident on the exit pupil will be an appropriate value.

In a seventh aspect, the invention is configured such that, in the decentered optical system according to the first aspect, a rotatable reflecting surface is disposed on the optical path in proximity to the exit pupil.

According to this invention, it is possible to deflect substantially parallel light beam exiting from the exit pupil by using the rotatable reflecting surface. In addition, it is possible to vary the angle of incidence to the focusing device and move the image formation position on the light receiving surface. At this time, by the rotatable reflecting surface being disposed on the optical axis in proximity to the exit pupil, it is possible to make the active surface of the reflecting surface small.

In an eighth aspect of the invention, in the decentered optical system according to the seventh aspect, the rotatable reflecting surface is formed by a galvano-mirror.

According to this invention, because a galvano-mirror is used, it is possible to carry out high speed and high precision light deflection.

In a ninth aspect, the invention is configured such that, in the decentered optical system according to the first aspect, at least one first optical path splitting device is disposed on the image side of the exit pupil, and a light receiving surface is disposed at optical paths that have been split at the first optical splitting device.

According to this invention, because light receiving surfaces are disposed on the optical paths after the optical path of substantially parallel light beam on the image side of the exit pupil has been split by at least a first optical splitting device, a plurality of light receiving surfaces are formed, and these surfaces can be used for multiple purposes.

In a tenth aspect, the invention is configured such that, in the decentered optical system according to the first aspect, a second optical path splitting device that splits the optical path is provided on the optical path between the decentered reflecting surface of the second optical element and the optically active surface of the third optical element, where the optically active surface has a positive power.

According to this invention, because the second optical path splitting device splits the optical path between the decentered reflecting surface and the optically active surface of the third optical element, where this optically active surface has a positive power, the light beam is split before the exit pupil is formed, and thereby these beams can be used for many purposes.

In an eleventh aspect, the invention is configured such that, in the decentered optical system according to the tenth aspect, another intermediate image is formed on the optical path that has been split by providing the second optical path splitting device on the object side at the position where the intermediate image is formed, and an intermediate image light receiving surface is disposed at the position of the image plane of the other intermediate image.

According to this invention, because another intermediate image is formed on the optical path that has been split by the second optical path splitting device and the intermediate image light receiving surface is disposed at the position of this image plane, it is possible to provide a light receiving surface that is separate from the light receiving surface on which the focusing device focuses. In addition, because the other intermediate image is provided at the image side of the second optical element, like the intermediate image on the optical path that has not been split off, the aberration of this intermediate image can be corrected with high precision by the first and second optical elements.

Moreover, in order to solve the problems described above, in a twelfth aspect, the present invention is a decentered optical system in which a substantially afocal optical system formed in which a substantially parallel light beam serves as the input light, and wherein a first, second, and third optical elements respectively having a positive, negative, and positive power are disposed in order along the optical path of the input light, a rotationally asymmetric decentered reflecting surface that is disposed decentered from the optical axis of the input light is provided on the first and second optical elements, an intermediate image is formed along the optical path by the first through third optical elements and an exit pupil is formed on the image side of the third optical element, and a focusing device having a positive power that forms the substantially parallel light beam emitted from the exit pupil into an image on a light receiving surface is disposed on the optical path on the image side of the exit pupil, and when the surface that includes the input light and the axial principal rays of the light beam reflected by the first and second optical elements serves as the Y-Z plane, the direction in which the axial principal ray progresses from the object to the reflecting surface of the first and second optical elements serves as the Z-axis, the direction perpendicular to the Z-axis in the Y-Z plane serves as the Y-axis, and the direction perpendicular to the Y-Z plane serves as the X-axis, then the maximum field angle θ_{0y} in the Y direction on the object side, the maximum field angle θ_{ey} in the Y direction in the exit pupil, the image height h of the intermediate image, and the diameter of the entrance pupil D₀ satisfy the following formula:
1.5<[{(θ_{cy}/θ_{oy})+2}×(h/tan θ_{ey})]/D₀<10

According to this invention, a substantially afocal optical system is formed wherein the first through third optical elements form an intermediate image along the optical path and an exit pupil is formed on the image side of the third optical element. That is, when an input light that is a substantially parallel light beam is incident on a first optical element and then is reflected by a decentered rotationally asymmetric reflecting surface having a positive power, the optical path can be folded to generate a converging beam. In addition, when this converging beam is incident on the second optical element and then is reflected by a rotationally asymmetric decentered reflecting surface having a negative power, the optical path is folded, and an intermediate image is formed along this optical path. When the light beam that diverges after forming the intermediate image has reached the third optical element due to the position of the focal point of the third optical element being disposed approximately at the position of the intermediate image, the light beam is made a substantially parallel light beam due to the positive power thereof to form an exit pupil on the image side. That is, the first and second optical elements form an objective optical system and the third optical element forms an ocular optical system.

In addition, the light beam emitted from the exit pupil is formed into an image on the light receiving surface by a focusing device having a positive power.

In this manner, there is no obstruction of the optical path and there is no light loss due to folding the optical path by providing a decentered reflecting surface on the second optical element, and furthermore, a compact optical system becomes possible.

Here, in order to form such a compact optical system reliable, the Y direction maximum field angle θ_{0y} on the object side, the maximum field angle θ_{ey} in the Y direction in the exit pupil, the image height h of the intermediate image, and the entrance pupil diameter D₀ satisfy the following equation:
1.5<[{(θ_{ey}/θ_{oy})+2}×(h/tan θ_{ey})]/D₀<10 (7)

According to equation (7), the disposition of the decentered reflecting surfaces that are the first and second optical elements can be suitably set, the optical path length of the substantially afocal optical system and a large field angle can be maintained, and it is possible to make a decentered optical system having a compact configuration. In addition, because an afocal optical system is formed, when an optical path splitting element or the like is disposed between third optical element and the focusing device, the effective diameter of the third optical element can be approximately the diameter of the exit pupil, and it is possible to make an optical system that easily handles high performance.

In addition, because the decentered reflecting surfaces of the first and second optical elements each have a rotationally asymmetric decentered reflecting surface, the surface form within the effective diameter on each side in the Y direction surrounding an axial principal ray is varied depending on the amount of decentration such that the curvature and the tilting becomes asymmetric with respect to the axial principal ray, and thereby astigmatism and coma aberration on the axis and aberration due to decentration such as distortion can be advantageously corrected.

Therefore, the image formation capacity of the intermediate image formed by these optical elements can be made advantageous.

In a thirteenth aspect of the invention, in the decentered optical system described in the nineteenth aspect, when the points at which an axial principal ray is reflected by the respective decentered reflecting surfaces of the first and second optical elements are denoted by point M₁ and point M₂, the Z direction component L_{z} of the distance between the point M₁ and the point M₂, and the effective diameters D₁ and D₂ of their respective decentered reflecting surfaces satisfy the following equation:
0.35<{(D₁+D₂)/2}/1_{z}<2.0 (11)

According to equation (11), when an axial principal ray is reflected from the first optical element, which is a decentered reflecting surface, towards the second optical element, the light beam is not obstructed by the optical elements, a reflecting angle that can advantageously correct the aberration caused by the decentered reflecting surface can be set, and a compact and high resolution decentered optical system can be attained.

In a fourteenth aspect of the invention, in the decentered optical system described in the twelfth aspect, the Y direction incident maximum field angle θ_{my} from the object side and the focal distance F_{oy} in the Y direction of the objective optical system in the substantially afocal optical system that consists of the first and second optical elements satisfy the following equation:
0.5 (mm)<F_{oy}·tan θ_{my}<4.0 (mm) (15)

Here, the focal distance of the objective optical system in the present specification will be explained. In the present specification, the objective optical system provides two decentered reflecting surfaces having a rotationally asymmetric surface shape, and the focal distance cannot be calculated as a paraxial amount. Thus, the focal distance F_{oy} (mm) in the Y direction of the object optical system is defined as the NA at the intermediate image plane (where the angle formed by the axial principal ray when the ray is incident on the intermediate image plane is denoted φ, NA=sin φ) divided by a minute amount H when a light ray is traced that passes through a point offset by a minute amount (mm) in the Y direction from the center of the entrance pupil and is incident on the optical system parallel to the axial principal ray.

According to this invention, because F_{oy}·tan θ_{my} satisfies the range of equation (15), the size of the image height of the intermediate image formed along the optical path of the substantially afocal optical system can be accommodated in an advantageous range. As a result, the image formation capacity for the intermediate image is advantageous, the size of the decentered optical system can be made compact.

In a fifteenth aspect of the invention, in the decentered optical system described in the twelfth aspect, when the angle between a principal ray and a characteristic ray of the axial light beam incident on the exit pupil is denoted by θ, the following equation is satisfied:
−3≦θ≦4° (13)

According to this invention, because the light beam incident on the exit pupil is made a substantially parallel light beam limiting divergence and convergence due to the angle θ falling in a range from a lower limiting value of −3° to an upper limiting value of +4°, the size of the diameter of the light beam in the exit pupil can be maintained substantially constant. In addition, even in the case that the diameter of the exit pupil at the exit pupil position fluctuates due to manufacturing error or installation error of the other optical elements, the amount of fluctuation becomes small, and therefore, for example, when an optical element is disposed in proximity to the exit pupil plane and the light beam is reflected or diffracted, it is possible to make the effective diameter of the optically active surface of the optical element small. In addition, it is possible to prevent light loss due to obstruction.

In a sixteenth aspect of the invention, in the decentered optical system described in the twelfth aspect, the entrance pupil diameter Do, the incident field angle θ₁ of the input light towards the entrance pupil, and the incident field angle θ₂ of a principal ray when the input light is incident on the exit pupil satisfy the following equation:
0.2 (mm)≦D₀·(θ₁/θ₂)≦40 (mm) (16)

According to this invention, because (θ₁/θ₂) is the angular magnification, based on equation (16), a decentered optical system is formed such that the exit pupil diameter is 0.2 mm to 40 mm when the input light and the incident light towards the exit pupil are parallel. Therefore, the exit pupil diameter has an appropriate value, and a rationally configured decentered optical system can be formed.

In a seventeenth aspect of the invention, in the decentered optical system described on the twelfth aspect, the distance L₂, along an axial principal ray from the optically active surface closest to the image side of the third optical element to the position of the exit pupil and the entrance pupil diameter D₀ satisfy the following equation:
0.01≦(L₂₁/D₀)≦0.7 (17)

According to this invention, because the ratio of the distance L₂₁ along an axial principal ray from the optically active surface closest to the image side of the third optical element to the position of the exit pupil to the entrance pupil diameter D₀ falls within the range of equation (11), there is no obstruction of the light beam, and furthermore, a decentered optical system having a compact size becomes possible.

In a eighteenth aspect of the invention, in the decentered optical system according to the twelfth aspect, the intermediate image is formed at a position between the decentered reflecting surface of the second optical element and the third optical element.

According to this invention, an intermediate image can be formed that has a favorable aberration correction due to the first and second optical elements.

In a nineteenth aspect of the invention, in the decentered optical system described in the twelfth aspect, the distance L₂₂ along an axial principal ray from the position where the intermediate image is formed to optically active surface closest to the image side of the third optical element and the entrance pupil diameter D₀ satisfy the following equation:
0.015≦(L₂₂/D₀)≦0.7 (14)

According to this invention, because the ratio of the distance L₂₂ along an axial principal ray from the position at which the intermediate image is formed to the optically active surface closest to the image side of the third optical element to the entrance pupil diameter D₀ falls within the range of equation (14), the size of the angular magnification and the distance L₂ becomes appropriate, and it is possible to position the third optical element so as not to block the intermediate image.

In a twentieth aspect of the invention, in the decentered optical system described in the twelfth aspect, the distance L₂₃ along an axial principal ray from the decentered reflecting surface of the second optical element to the position at which the intermediate image is formed and the entrance pupil diameter Do satisfy the following equation:
0.1≦(L₂₃/D₀)≦10 (12)

According to this invention, because the ratio of the distance L₂₃ along an axial principal ray from the decentered reflecting surface of the second optical element to the position at which the intermediate image is formed to the entrance pupil diameter D₀ fall within the range of equation (12), the decentered reflecting surface has an appropriate size, it is possible to carry out high precision aberration correction of the spherical aberration and the coma aberration due to the decentered reflecting surfaces of the first and second optical elements, and it obstruction of the light beam due to the second optical element will not occur.

In a twenty-first aspect of the invention, in the decentered optical system described in the twelfth aspect, a configuration is used wherein a rotatable reflecting surface is disposed on the optical path in proximity to the exit pupil.

According to this invention, due to the rotatable reflecting surface, it is possible to deflect the substantially parallel light beam emitted from the exit pupil. In addition, it is possible to vary the incident angle towards the focusing device and move the position of image formation on the light receiving surface. At this time, it is possible to make the effective surface of the reflecting surface small due to the rotatable reflecting surface being disposed on the optical path in proximity to the exit pupil.

In a twenty-second aspect of the invention, in the decentered optical system described in the twenty-first aspect, a decentered optical system is formed that is characterized in that the rotating reflecting surface is formed by a galvano-mirror.

According to this invention, because a galvano-mirror is used, it is possible to carry out high speed and high precision optical deflection.

In a twenty-third aspect of the invention, in the decentered optical system described in the twelfth aspect, the decentered reflecting surface of the first optical element consists of a free-formed surface that has only one plane of symmetry.

According to this invention, because the decentered reflecting surface of the first optical element is formed by a free-formed surface that has only one plane of symmetry, it is possible to correct the particular aberration caused by decentration that occurs in addition to normal aberration at the decentered reflecting surface, aberration correction becomes possible by forming a surface shape in which the optical axis is limited to the inside of the effective diameter and the rotationally asymmetric surface and tilt are different. Examples of aberration caused by decentration included astigmatism and coma aberration on the axis, and bow and trapezoid shaped distortion (image distortion) particular to aberration caused by decentration and the like. Therefore, it is possible to make a decentered optical system having an advantageous image forming capacity.

In a twenty-fourth aspect of the invention, in the decentered optical system described in the twelfth aspect, the decentered reflecting surface of the second optical element consists of a free-formed surface having only one plane of symmetry.

According to this invention, because the decentered reflecting surface of the second optical element is formed by a free-formed surface that has only one plane of symmetry, it is possible to correct the particular aberration caused by decentration that occurs in addition to normal aberration at the decentered reflecting surface by forming a surface shape in which the optical axis is limited to the inside of the effective diameter and the rotationally asymmetric surface and tilt are different. Therefore, it is possible to make a decentered optical system having an advantageous image forming capacity.

In a twenty-fifth aspect of the invention, in the decentered optical system described in the twelfth aspect, the third optical element provides an optically active surface that consists of a rotationally asymmetric surface.

According to this invention, because the third optical element provides an optical active surface that consists of a rotationally asymmetric surface, even when aberration caused by decentration remains in the intermediate image, aberration correction becomes possible by forming a surface shape in which the optical axis is limited to the inside of the effective diameter and the rotationally asymmetric curvature and tilt are different. Furthermore, when the third optical element has a decentered reflecting surface, it is possible to suppress the occurrence of aberration caused by decentration. Therefore, it is possible to make a decentered optical system having an advantageous image forming capacity.

In a twenty-sixth aspect of the invention, in the decentered optical system described in the twelfth aspect, the third optical element provides an optically active surface that consists of a free-formed surface that has only one plane of symmetry.

According to this invention, because the third optical element provides an optical active surface that consists of a rotationally asymmetric surface, even when aberration caused by decentration remains in the intermediate image, aberration correction becomes possible by forming a surface shape in which the optical axis is limited to the inside of the effective diameter and the rotationally asymmetric curvature and tilt are different. Furthermore, when the third optical element has a decentered reflecting surface, it is possible to suppress the occurrence of aberration caused by decentration. Therefore, it is possible to make a decentered optical system having an advantageous image forming capacity.

In a twenty-seventh t aspect of the invention, in a light transmitting device, the configuration includes a light source that radiates a substantially parallel light beam.

According to this invention, it is possible to make a light transmitting device having an operational effect identical to the inventions described in the twelfth aspect.

In a twenty-eighth aspect of the invention, in the light transmitting device described in the thirty-fourth aspect, a light beam merging device for making the substantially parallel light beam emitted from the light source incident on the exit pupil is provided.

According to this invention, because an optical path merging device is provided, the substantially parallel light beam emitted from the light source can be made incident on the exit pupil easily.

In a twenty-ninth aspect of the invention, the decentered optical system described in the twelfth aspect is provided, and at least one of the light receiving surfaces is formed by a position detecting sensor.

According to this invention, it is possible to detect the light receiving position by the position detecting sensor.

In a thirtieth aspect of the invention, in the light receiving device, the decentered optical system described in the twelfth aspect, a light receiving device provided on the light receiving surface of the decentered optical system, and an input signal control device connected to the light receiver are provided.

According to this invention, it is possible to make a light receiving device having an operation and effects identical to that of the inventions described in the twelfth aspect.

A thirty-first aspect of the invention is an optical system that includes an optical transmitting device that emits a substantially parallel light beam, and an optical receiving device that is disposed separated from and opposed to the optical transmitting device and receives the substantially parallel light beam as input light, wherein the light receiving device provides the decentered optical system described in the twelfth aspect.

According to this invention, it is possible to make an optical system that has the same operation and effects as those of the inventions described in the twelfth aspect.

In a thirty-second aspect of the invention, in the optical system described in the thirty-first aspect, at least one of the light receiving surfaces of the light receiving device is formed by a position detecting sensor, and light capture and tracking are carried out based on the position signal from the position detecting sensor.

According to this invention, because a position detecting sensor is provided on the light receiving surface, it is possible to carry out high precision light capture and tracking.

In a thirty-third aspect of the invention, in the optical system described in the thirty-first aspect, a configuration is made in which the light transmitting device has an output signal control device, and light receiving device has an input signal control device, and the communication signal is received and transmitted after modulation, and thereby optical communication in space can be carried out.

According to this invention, optical communication in space can be carried out with little loss of light. In particular, it is possible to carry out stable and highly reliable optical communication in space if light capture and tracking is carried out.

### BRIEF DESCRIPTION OF THE DRAWINGS

FIG. 1 is a cross-sectional optical path diagram that includes the optical path on the axial principal ray for explaining an example of the decentered optical system according to a first embodiment of the present invention.

FIG. 2 is a cross-sectional optical path diagram that includes the optical path on the axial principal ray for explaining a first modification of the first embodiment of the present invention.

FIG. 3 is a cross-sectional optical path diagram that includes the optical path on the axial principal ray for explaining a second modification of the first embodiment of the present invention.

FIG. 4 is a cross-sectional optical path diagram that includes the optical path on the axial principal ray for explaining a third modification of the first embodiment of the present invention.

FIG. 5 is a cross-sectional optical path diagram that includes the optical path on the axial principal ray for explaining a fourth modification of the first embodiment of the present invention.

FIG. 6 is a cross-sectional optical path diagram that includes the optical path on the axial principal ray for explaining a fifth modification of the first embodiment of the present invention.

FIG. 7 is a cross-sectional optical path diagram that includes the optical path on the axial principal ray for explaining a sixth modification of the first embodiment of the present invention.

FIG. 8 is an optical path diagram that includes the optical path of an axial principal ray in order to explain an example of the decentered optical system according to a second embodiment of the present invention.

FIG. 9 is an optical path diagram that includes the optical path of an axial principal ray in order to explain a first modification of the second embodiment of the present invention.

FIG. 10 is an optical path diagram that includes the optical path of an axial principal ray in order to explain a second modification of the second embodiment of the present invention.

FIG. 11 is an optical path diagram that includes the optical path of an axial principal ray in order to explain a third modification of the second embodiment of the present invention.

FIG. 12 is a cross-sectional schematic diagram for explaining an example of the schematic configuration of the light capture and tracking device according to a third embodiment of the present invention.

### DETAILED DESCRIPTION OF THE INVENTION

Below, embodiments of the present invention will be explained with reference to the figures. Moreover, in all of the figures, identical or corresponding members in different embodiments have identical reference numerals, and identical explanations are omitted.

First Embodiment

The decentered optical system according to the first embodiment of the present invention will be explained.

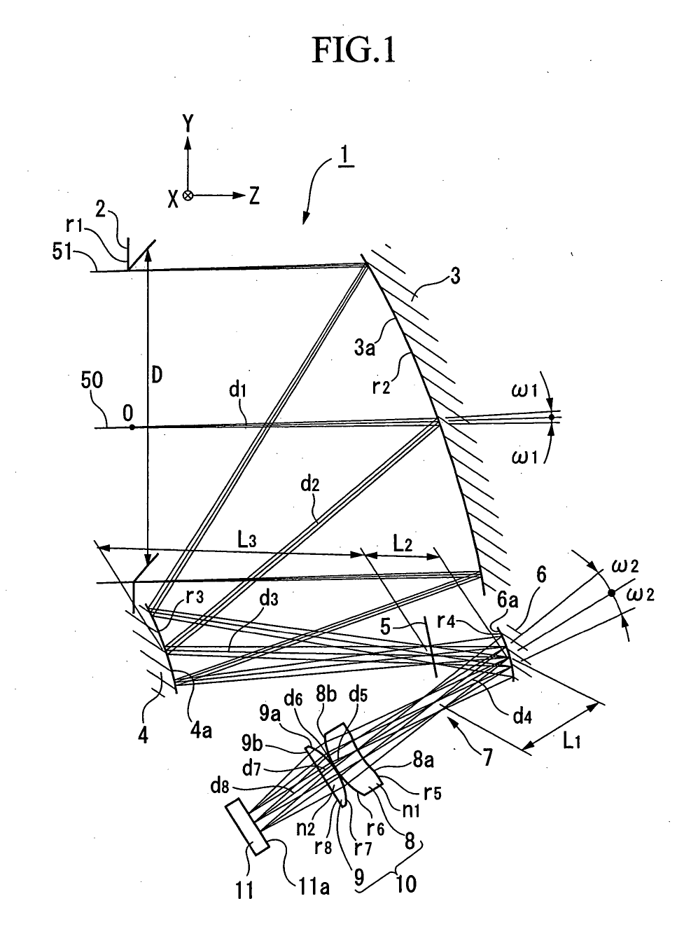

FIG. 1 is a cross-sectional optical path diagram that includes the optical path on an axial principal ray for explaining an example of the decentered optical system according to a first embodiment of the present invention. Note that when the optical path has an incident field angle of 0° and an incident field angle ±ω around the axis perpendicular to the page surface, the light beam is traced by the principal ray and two characteristic rays.

The decentered optical system 1 according to a first embodiment of the present invention will be explained.

The decentered optical system 1 is for forming an image on a light receiving surface 11a after a substantially parallel incident light beam 51 (input light) is made incident on the system, and the schematic structure thereof consists of an aperture stop 2, a reflecting mirror 3 (first optical element), a reflecting mirror 4 (second optical element), a reflecting mirror 6 (third optical element), a focusing device 10, and a light receiver 11.

The aperture stop 2 is for restricting the light beam diameter of the incident light beam 51, and serves as the entrance pupil of the decentered optical system 1. In the present embodiment, this aperture stop 2 is a round hole step having a diameter D. Among the principal rays, the axial principal ray 50 passes through the center O of the aperture stop 2 and is then incident on the center of the light receiving surface. In addition, the optical path that is aligned with the axial principal ray serves as the optical axis.

Note that in the present embodiment, an incident field angle can be in a direction perpendicular to the page surface of the figure. However, in the following, in order to simplify the explanation, a two-dimensional in-plane optical path that includes the optical path of the axial principal ray 50 will be explained, and the three-dimensional optical paths will be explained as necessary. The explanation of a two-dimensional optical path can easily be extended to the three-dimensional optical path.

The reflecting mirror 3 is an optical element for folding and focusing the optical path by reflecting the incident light beam 51 that has passed through the aperture stop 2. The reflecting surface 3a is formed by a free-formed surface consisting of a rotationally asymmetric curved surface having a positive power. In addition, in order to guide the reflected light away from the incident light beam 51 of the object, the reflecting surface 3a is disposed decentered counterclockwise (the positive direction around the X-axis of the coordinate system described below) when seen from the axis perpendicular to the page surface of the figure.

In addition to the normally occurring aberration, the shape of the reflecting surface 3a corrects the particular aberration caused by decentration that occurs due to the decentering of the reflecting surface 3a. Examples of such aberration are astigmatism and coma aberration on the axis, and bow and trapezoid shaped distortion (image distortion) particular to aberration caused by decentration and the like. Thus, preferably the reflecting surface 3a is a rotationally asymmetric curved surface such that only the plane (the Y-Z plane in the coordinate system described below) aligned with the page surface of the figure is a symmetric surface.

The reflecting mirror 3 serves as the optical element closest to the object side, and mainly imparts the power of the decentered optical system 1.

Here, the coordinate system for expressing the rotationally asymmetric surface and free form surface will be explained for the present embodiment.

As shown in FIG. 1, in the coordinate system, by tracing a ray from the object side towards the aperture stop 2 and the reflecting mirror 3, the incident optical axis is defined to be the light ray among the axial principal rays 50 that is perpendicular to the center of the aperture stop 2 that forms the aperture surface and reaches the center of the transmitting surface 3 of the prism 1. In addition, in the ray tracing, the origin 0 of the decentered optical plane of the decentered optical system is defined as the center of the aperture stop 2 (where the illustrated coordinate axes are offset from the position of the origin point in order to avoid overlap with the optical path), and where the direction along the incident optical axis is defined as the Z-axis direction, the direction from the object towards the aperture stop 2 of the decentered optical system is defined as the positive Z-axis direction, the page surface defines the Y-Z plane, the direction from the surface to the back of the page is defined as the positive X-axis direction, and the axis that forms the right-handed rectangular coordinate system with respect to the X-axis and Z-axis is defined as the Y-axis.

Where the tilt angles centered on the X-axis, Y-axis, and Z-axis are denoted α, β, and γ, positive tilt angles α and β are defined by a clockwise rotation with respect to the positive direction of the X-axis and Y-axis, and the positive tilt angle γ is defined by a clockwise rotation with respect to the positive direction of the Z-axis.

In addition, when representing each of the optically active surfaces by a coordinate system, the axial principal ray 50 is traced by a forward light ray in the direction from the object towards the image plane, and an optically active surface is represented by a local coordinate system rotated on the Y-axis and Z-axis such that the point where the optically active surface and the axial principal ray 50 intersect is defined as the origin, and the Z-axis is aligned with the axial principal ray 50 while maintaining the X-axis perpendicular to the page surface.

Note that when rotating α, β, and γ on the center axis of the plane, the center axis of the plane and the rectangular XYZ coordinate system thereof is rotated counterclockwise through an angle α around the X-axis; next, the center axis of this rotated surface is rotated counterclockwise through an angle β around the Y-axis of the new coordinate system; the coordinate system that has been rotated one time is also rotated counterclockwise through an angle β around the Y-axis; and next the center axis of the plane that has been rotated twice is rotated clockwise through an angle γ around the Z-axis of the new coordinate system.

The shape of the rotationally asymmetric spherical surface used in the present embodiment is represented, for example, by a free-form surface defined by the following equation (a). The Z-axis of the equation (a) is the axis of the free-formed surface.

$$Z = ( {r}^{2} / R ) / [ 1 + \sqrt{\{ 1 - ( 1 + k ) {( r / R )}^{2} \}} ] + ( {ar}^{4} + {br}^{6} + {cr}^{8} + {dr}^{10} + … ) + {\sum }_{j = 1}^{66} {C}_{j} {X}^{m} {Y}^{n} \qquad ( a )$$

Here, the terms 1 and 2 of the equation (a) are the spherical surface terms, and term 3 is the free-formed surface term. In the spherical surface terms, R denotes the radius of curvature at the vertex, k denotes the conic constant, and r=√(X¹+Y²)

The free-formed surface term is:

$${\sum }_{j = 1}^{66} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7}$$

where Cⱼ (j is an integer equal to or greater than 1) is a coefficient.

Generally, the free-formed surface represented by the equation (a) does not have a symmetrical surface on both the X-Z surface and the Y-Z surface, but it is possible to form a free-formed surface having only one symmetrical surface perpendicular to the Y-Z surface by making all the odd number terms for X equal to 0. For example, in equation (a) defined above, this is possible by making each of the coefficients C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . equal to 0.

The reflecting mirror 4 is an optical element that reflects the light beam reflected by the reflecting mirror 4, and folds the optical path into a region that is not blocked by the reflecting mirror 3. At the same time, while correcting the aberrations caused by decentration, the reflecting mirror 4 forms the intermediate image at the intermediate image plane 5 at a predetermined position on the image side. Thereby, the reflecting surface 4a (decentered reflecting surface) is formed by a free-formed surface consisting of a rotationally asymmetric surface having a positive power, and is disposed decentered around the X-axis.

The reflecting surface 4a is shaped to correct not only normally occurring aberration, but also the particular aberration caused be decentration due to the decentering of the reflecting surface 3a, such as astigmatism and coma aberration that occur on the axis, and bow and trapezoid shaped distortions particular to aberration caused by decentration. In order to attain this, preferably the reflecting surface 4a is a rotationally asymmetric surface such that only the Y-Z plane is a symmetric surface.

In addition, by suitably combining the surface shapes of the reflecting surfaces 3a and 4a, the intermediate image plane 5 is formed at the position where the distance along the optical axis from the reflecting surface 4a to the intermediate image plane 5 is the distance L₃.

The reflecting mirror 6 is an optical element that reflects the light ray after being reflected by the reflecting mirror 4 and forming the intermediate image at the intermediate image plane 5, and folds the optical path into a region that is not blocked by other optical elements. The reflecting mirror 6 focuses the light beam from the intermediate image plane 5 that diverges towards the image side into a substantially parallel light beam. In order to attain this, the reflecting surface 6a (the optically active surface having a positive power) is formed by a free-formed surface consisting of a rotationally asymmetric surface having a positive power.

Preferably, the shape of the reflecting surface 6a is a rotationally asymmetric surface having a symmetric surface only in the Y-Z plane so that the aberration caused by the decentration due to the decentered position of the reflecting surface 6a can be corrected.

The reflecting mirror 6 is disposed at a position where the distance along the optical axis from the intermediate image plane 5 to the reflecting surface 6a is the distance L₂.

The reflecting mirrors 3, 4, and 6 form a substantially afocal optical system in which an intermediate image is formed and a substantially parallel incident light beam 51 is emitted as a substantially parallel light beam. Therefore, on the image side of the reflecting mirror 6, an exit pupil 7 is formed at the position where the distance along the optical axis from the reflecting surface 6a is the distance L₁.

The focusing device 10 is an optical element having a positive power that is provided decentered on the image side of the exit pupil 7, and focuses the substantially parallel light beam reflected by the reflecting mirror 6 on the light receiving surface 11. In the present embodiment, the focusing device 10 consists of a lens 8 and a lens 9. The lens 8 has a positive power and is formed, in order from the object side, by the spherical concave surface 8a and convex surface 8b. The lens 9 has a positive power and is formed, in order from the object side, by a spherical convex surface 9a and convex surface 9b.

The light receiver 11 is an element having a light receiving surface 11a that receives the light focused by the focusing device. In addition, it is possible to dispose an optical fiber, photodiode (below, PD), a quarter PD (QD), an optical position sensitive detector (below, PSD), a charge coupled device (below, CCD), and the like as this element.

When using an optical fiber, because opto-electrical conversion along the path is not necessary, light transmission having ideal efficiency can be carried out. When using a PD, it is possible to widen the area by direct coupling to an optical fiber by carrying out opto-electrical conversion of the optical signal at the light receiving surface, and compared to an optical fiber, precision is not necessary. These two are used as light receiving elements for light that carries a signal.

When using a QD, because the light receiving surface is divided into four areas, and the light receiving position is detected by calculating the signal intensity of the four areas. In addition, if a signal is extracted based on variations in the intensity of the received light, it is possible to use this as-is with a light receiving element for an optical signal. When using a PSD, it is possible to detect the focused position in two dimensions.

When using a CCD, it is possible to observe the received image and detect the position by image processing and calculating based on the focused position.

In the present embodiment, because the divergence and convergence of the light beam incident on the exit pupil 7 are suppressed and the size of the light beam diameter at the exit pupil 7 is maintained substantially constant, where the angle between the principal ray and the subsidiary (characteristic) ray of the light beam on the axis is denoted by θ, the substantially parallel light beam reflected by the reflecting mirror 6 satisfies the following equation:
−6°≦θ≦8° (1)

Here, a positive reference number denotes the direction in which the subsidiary ray of the incident light spreads with respect to the axial principal ray when progressing towards the image plane, and negative in the contrary case. The subsidiary ray is defined as the ray other than the principal ray of the light beam on the axis.

When the angle θ is larger than the upper limiting value, the angle of the divergence of the light beam becomes too large, the focusing device 10 after passage through the exit pupil becomes large, and thus the scale of the optical system as a whole becomes large.

When the angle θ is smaller than the lower limiting value, the distance from the exit pupil 7 to the focusing device 10 becomes short, and thus the NA of the focusing device 10 becomes small, and it becomes possible to attain a high resolution.

In addition, the conditions of equation (1) define a range in which carrying out stable high performance at the optical path after reflection and bending becomes possible when the light beam is reflected and bent at the exit pupil surface.

In order to form an exit pupil 7 having less fluctuation of diameter, preferably the range is one in which the angle θ is more narrow than the range defined by the conditions of equation (1). Preferably,
−5°≦θ≦7.5° (1a)

More preferably,
−3°≦θ≦7° (1b)

Note that in the present embodiment, preferably a configuration is used wherein any of the following conditions or a suitable combination thereof is satisfied.

In order to make the aberration correction simple and attain a favorable image formation capacity, and at the same time prevent the scale of the optical system from becoming large, preferably the incident field angle ω₁ of the incident light beam 51 towards the entrance pupil, the incident field angle ω₂ of the principal ray when the incident light beam 51 is incident on the exit pupil 7, and the entrance pupil diameter D satisfy the following equation:
0.5 (mm)≦D·(ω₁/ω₂)≦15 (mm) (2)

When the exit pupil is larger than the upper limiting value, the diameter of the light beam incident on the exit pupil 7 becomes large, and thereby the scale of the focusing device 10 at the image side of the exit pupil 7 becomes large.

In addition, when the exit pupil is smaller than the lower limiting value, the angular magnification becomes too large and the aberration correction becomes insufficient for an input light having an sufficient entrance pupil equal to or greater than 10 mm, and thus advantageous image formation at the light receiving surface 11a becomes difficult.

In order for to provide a more suitable value to the exit pupil diameter and provide a decentered optical system having a more superior image formation capacity, the value of D·(ω₁/ω₂) is preferably within a range more narrow than the conditions of equation (2). Preferably,
0.8 (mm)≦D·(107 ₁/ω₂)≦9 (mm) (2a)

More preferably,
1.2 (mm)≦D·(ω₁/ω₂)≦7.5 (mm) (2b)

In order that the position at which the exit pupil 7 is formed is not too far from the reflecting surface 6a, the distance L₁ and the entrance pupil diameter D preferably satisfy the following equation:
0.05≦(L₁/D)≦3 (3)

When the ratio L₁/D is larger than the upper limiting value, the distance from the reflecting mirror 6 to the exit pupil 7 becomes long, and thus the scale of the decentered optical system 1 becomes large.

In addition, when the ratio L₁/D is smaller than the lower limiting value, the distance from the reflecting mirror 6 to the exit pupil 7 becomes too short, and when, for example, high performance is to be realized by disposing a reflecting optical element at the exit pupil 7, it becomes difficult to dispose such an optical element because it will interfere with the reflecting mirror 6.

In order to provide ample space in proximity to the exit pupil position while making the optical system more compact, the ratio L₁/D preferably falls within a range that is more narrow than the conditions of equation (3). Preferably,
0.1≦(L₁/D)≦1.5 (3a)

More preferably,
0.15≦(L₁/D)≦1 (3b)

In order to impart a suitable light beam diameter to the substantially parallel light beam after reflection by the reflecting mirror 6, preferably the distance L₂ and the entrance pupil diameter D satisfy the following equation:
0.03≦(L₂/D)≦1.5 (4)

When the ratio L₂/D is larger than the upper limiting value, the distance from the intermediate image to the third optical system becomes long, the angular magnification becomes small, and the diameter of the light beam incident on the exit pupil 7 becomes large, and thus the scale of the device becomes large.

In addition, when the ratio L₂/D is smaller than the lower limiting value, the intermediate image plane 5 and the reflecting mirror 6 are too close, and thus the exit pupil 7 is also formed in proximity thereto. Thus, for example, when an optical element or the like is disposed in order to reflect or bend the light beam at the exit pupil 7, blocking by the reflecting mirror 6 occurs easily.

In order to provide ample space in proximity to the exit pupil 7 while imparting a more suitable diameter to the light beam incident on the exit pupil 7, the ratio L₂/D₀ preferably falls within a range that is more narrow than the conditions of equation (4). Preferably,
0.07≦(L₂/D)≦1.0 (4a)

More preferably,
0.09≦(L₂/D)≦0.5 (4b)

The position of the intermediate image plane 5 can be disposed varying the distance L₂ by suitably combining the surface shapes of the reflecting surfaces 3a and 4a.

The distance L₂ preferably satisfies the following equation with respect to the entrance pupil D so that the diameter of the light beam incident on the reflecting surface 4a has imparted a suitable size and the decentered optical system 1 does not make the intermediate image large.
0.3≦(L₃/D)≦3 (5)

When the ratio L₃/D₀ is larger than the upper limiting value, the distance from the reflecting surface 4a to the intermediate image plane 5 becomes too long, the effective diameter of the reflecting surface 4a becomes large, and the scale of the device becomes large.

When the ratio L₃/D₀ is larger than the lower limiting value, the effective diameter of the reflecting surface 4a becomes too small, and the higher order spherical aberration and coma aberration cannot be adequately corrected.

In order to make diameter of the light beam incident on the reflecting mirror 4 a more suitable size and to increase further the aberration correction capacity of the reflecting surface 4a, the ratio L₃/D preferably falls within a range more narrow than the conditions of equation (5). Preferably,
0.4≦(L₃/D)≦2.5 (5a)
More preferably,
   0.5≦(L₃/D)≦2.0 (5b)

In order to make the angular magnification of the optical system until the light beam is incident on the exit pupil 7 fall within a suitable range and impart a suitable value to the diameter of the substantially parallel light beam incident on the exit pupil 7, the paraxial composite focal distance f₁ of the reflecting mirror 3 and the reflecting mirror 7 and the paraxial focal distance f₂ of the reflecting mirror 6 satisfy the following equation.
4≦(f₁/f₂)≦60 (6)

When the ratio f₁/f₂ is larger than the upper limiting value, the angular magnification of the optical system becomes too large and aberration correction becomes inadequate.

In addition, when the ratio f₁/f₂ is smaller than the lower limiting value, the diameter of the exit pupil becomes large, and the scale of the device becomes large.

In order to attain more advantageous aberration correction and make the device more compact, preferably the ratio f₁/f₂ is made to fall within a range narrower than the conditions of equation (6). Preferably,
5≦(f₁/f₂)≦40 (6a)

More preferably,
6≦(f₁/f₂)≦30 (6b)

The operation of the decentered optical system of the present embodiment will now be explained.

As shown in FIG. 1, the diameter of incident light beam 51 is restricted to the entrance pupil diameter D by being incident on the aperture stop 2, and progresses towards the reflecting mirror 3. When the light beam reaches the reflecting surface 3a, it is focused by the positive power of the reflecting surface 3a, and depending on the direction of decentration of the reflecting surface 3a (the positive direction around the X-axis), the light path is folded and guided to the reflecting mirror 4, which is disposed at a position that does not block the incident light beam 51 before the reflecting mirror 3 or the aperture stop 2. At this time, if the reflecting surface 3a has imparted a rotationally asymmetric surface shape, and in particular, has imparted a rotationally asymmetric free-form surface in which only the Y-Z plane is a symmetrical surface, it is possible to advantageously correct the aberration caused by decentration.

At the reflecting mirror 4, the reflecting surface 4a is decentered in the positive direction around the X-axis, and is a rotationally asymmetric decentered reflecting surface having a negative power. Thus, the optical path can be folded at a position that does not block the incident light beam 51 before the reflecting mirror 3 and the reflecting mirror 3. Furthermore, the normal aberration and the aberration caused by decentration of the light beam reflected by the reflecting mirror 3 having a positive power can be advantageously corrected by changing the shape of the reflecting surface 4a along the side towards the characteristic ray in the positive Z-axis and Y-axis direction and changing the curvature and tilt depending on the respective amounts of aberration due to decentration that have occurred.

In addition, the light beam whose aberration has been corrected by being reflected by the reflecting mirror 4 is then converged to form an intermediate image at the intermediate image plane 5 at a position of distance L₃ from the reflecting mirror 4.

The light beam that has formed the intermediate image gradually diverges, reaches the reflecting mirror 6 positioned forward at distance L₂, and is reflected by the reflecting surface 6a. At this time, due to the positive power of the reflecting surface 6a, the incident diverged light beam becomes a substantially parallel light beam that satisfies equation (1).

The reflecting surface 6a is decentered in a positive direction around X-axis, and thus it is possible to fold the optical path at a position where the reflected light avoids the intermediate image plane 5 and is not blocked by the reflecting mirror 4. Therefore, light loss due to obstruction or the like caused by the reflecting mirrors 3, 4, and 6 does not occur, the optical path can be folded into a substantially “W” form, and thereby it is possible to form a compact optical system.

In addition, because the exit pupil 7 is formed so as to be positioned forward a distance L₁ on the image side, when high performance is imparted by adding an optical element to the decentered optical system 1, it is possible to make the effective diameter of the optical element small by positioning the optical element in proximity to the exit pupil 7. This means that it is possible to manufacture the optical element to be disposed inexpensively and position it easily. Therefore, there are the advantages that an optical system having high performance imparted to the decentered optical system 1 can be manufactured at a small scale and inexpensively.

A galvano-mirror that deflects a substantially parallel light beam reflected by the reflecting mirror 6 is an example of such an optical element. Thus, because the effective diameter of the reflecting mirror can be made small, there are the advantages that it is possible to make the scale of the galvano-mirror small and the deflection can be made faster.

In addition, filter elements and half-mirrors are examples of other optical elements. Because the effective diameter of these can be made small, there are the advantages that the part precision in increased, and inexpensive fabrication is possible even when an expensive coating is applied.

In addition, in the present embodiment, because the substantially parallel light beam emitted from the exit pupil 7 is guided to the light receiving surface 11a after being focused by the focusing device 10, there is the advantage that the layout of the optical device using the decentered optical system 1 can be made simple because the focusing device 10 can be freely positioned in the optical axis direction.

This means that it is possible to fold the optical path using a planar mirror and the light receiver can be disposed at a convenient position.

In addition, a device such as a beam splitter (a first optical path splitting device) that splits the optical path can be provided along the optical path of the substantially parallel light beam to split the optical path, and thereby light can be received by a plurality of light receivers 11 if separate focusing devices 10 and light receivers 11 are disposed along the optical path after splitting. At this time, by varying the optical path length up to the light receiving surfaces 11a, the amount of movement of the light beam on the light receiving surfaces 11a with respect to the incident field angle can be changed easily. At this time, the plurality of light receivers 11a do not need to be identical types of elements, but elements having differing functions and sensitivities can be used. Thereby, there is the advantage that multi-purpose light reception becomes possible.

Note that in the explanation described above, in the case of a light receiving optical system that receives the incident light beam 51 on a light receiving surface 11a, the operation from the object side of the decentered optical system 1 to the image plane was explained, but of course if these light paths are reversed, a light transmitting optical system that emits from the aperture stop 2 is formed. That is, by disposing a divergent light source at a position corresponding to the light receiving surface 11a and making a substantially parallel light beam from the image side of the exit pupil 7 incident thereto, the optical path is reversed, then reflected by the reflecting mirror 3, and a substantially parallel light beam can be emitted from the aperture stop 2 to the object side.

Here, a device that splits the optical path explained above can be used as the optical path merging device when the optical path is reversed.

First Modification

A first modification of the decentered optical system 1 will now be explained.

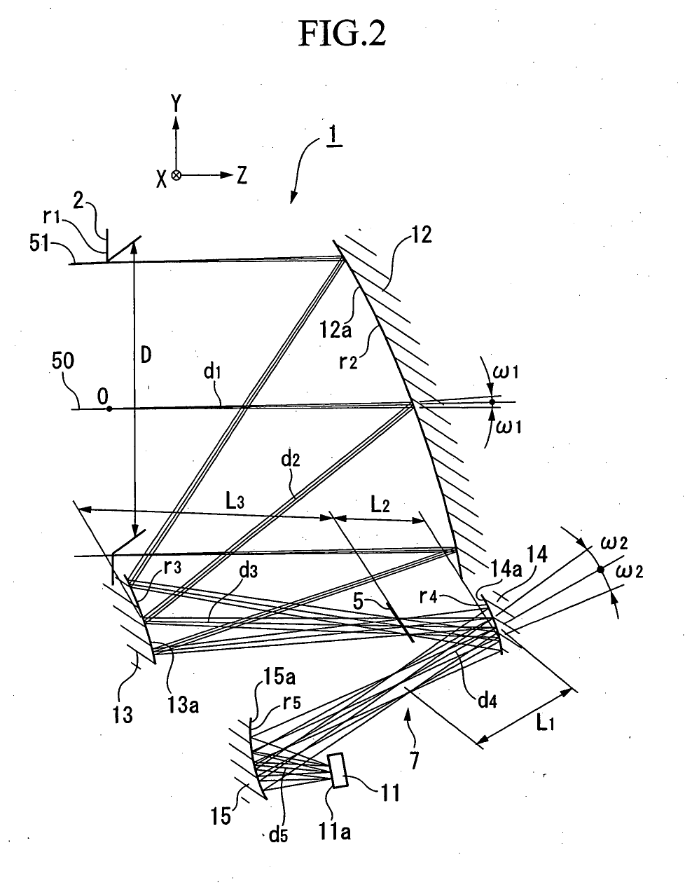

FIG. 2 is a cross-sectional optical path diagram that includes the optical path of an axial principal ray for explaining a first modification of the present embodiment.

Instead of the reflecting mirrors 3, 4, and 6 and the focusing device 10 in the above embodiment, this modification provides a reflecting mirror 12 (first optical element), a reflecting mirror 13 (second optical element), a reflecting mirror 14 (third optical element), and a reflecting mirror 15 (focusing device). Here, the coefficients of the free-formed surface and the amount of decentration of the reflecting surface 12a, reflecting surface 13a (decentered reflecting surfaces), and reflecting surface 14a (optically active surface having a positive power) of the reflecting mirrors 12, 13, and 14, differ only slightly from the corresponding reflecting surfaces 3a, 4a, and 6a, and have substantially identical functions. Thus, their explanation is omitted.

This modification is an example characterized by the point that the focusing device 10 formed by a lens system in the embodiment described above is here instead formed by using the reflecting mirror 15, which is a reflecting optical element.

The reflecting mirror 15 is a reflecting optical element having a positive power and consisting of a rotationally asymmetric surface. It is disposed decentered in the positive direction around the X-axis on the image side of the exit pupil 7 formed on the image side of the reflecting mirror 14.

According to this modification, because the substantially parallel light beam emitted through the exit pupil 7 is folded while being focused and directed to the light receiving surface 11a, a structure having a higher degree of freedom of design becomes possible.

In addition, because a decentered reflecting surface that consists of a rotationally asymmetric surface is used as the focusing device, in comparison to a lens optical system, there is the advantage that a favorable image forming capacity can be provided because chromatic aberration does not occur. In addition, because it is possible to decrease the number of parts, it is possible to reduce the cost.

Second Modification

A second modification of the decentered optical system 1 will now be explained.

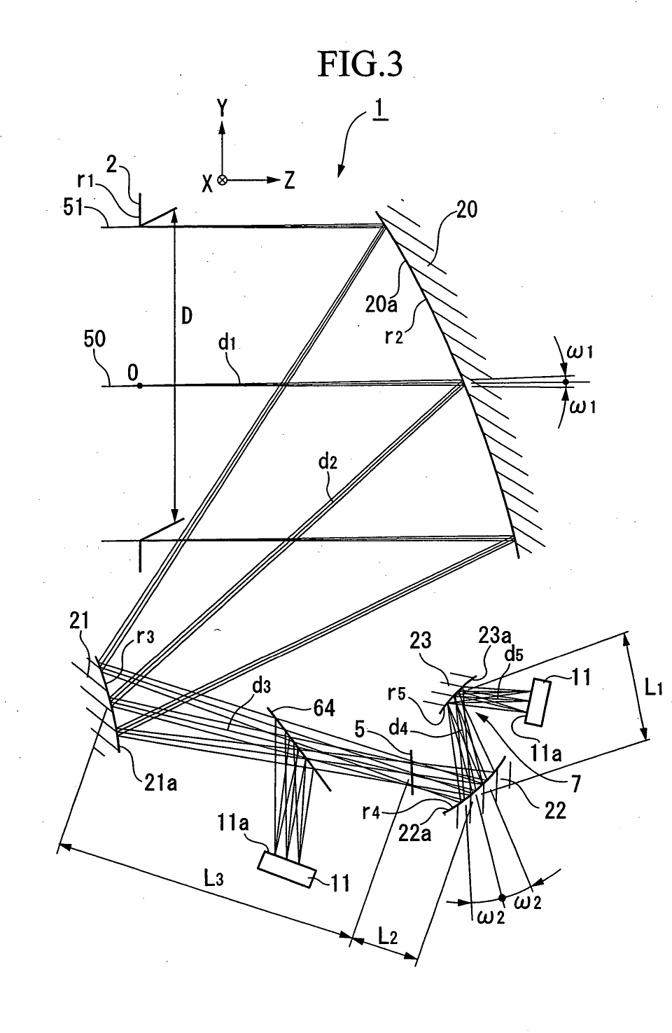

FIG. 3 is a cross-sectional optical path diagram that includes the optical path of an axial principal ray for explaining the second modification of the present embodiment.

Instead of the reflecting mirrors 3,4, and 6 and the focusing device 10 of the embodiment described above, the present modification provides a reflecting mirror 20 (first optical element), a reflecting mirror 21 (second optical element), a reflecting mirror 22 (third optical element), and a reflecting mirror 23 (focusing device), and further adds a beam splitter 64 (second optical path splitting device) and a light receiver 11. Here, the coefficients of the free-formed surface and the amount of decentration of the reflecting surface 20a, reflecting surface 21a (decentered reflecting surfaces), and reflecting surface 22a (optically active surface having a positive power) of the reflecting mirrors 20, 21, and 22 differ only slightly from the corresponding reflecting surfaces 3a, 4a, and 6a, and have substantially identical functions. Thus, their explanation is omitted.

The present modification is an example that is identical to the first modification on the point of using a focusing device 10 that is formed by a lens system and a reflecting mirror 23, which is a reflecting optical element, in the embodiment described above. However, the present modification is characterized by the location of the disposition thereof, and furthermore, is characterized by the optical path splitter that uses the beam splitter 64.

The reflecting mirror 23 is a reflecting optical element providing a reflecting surface 23a that consists of a concave spherical surface and that has a positive power, and the reflecting surface 23a is disposed at a position that substantially overlaps the exit pupil 7. In addition, the incident substantially parallel light beam is reflected, folded while being focused, and guided to the light receiving surface 11a.

The beam splitter 64 is disposed along the optical path between the reflecting mirror 21 and the intermediate image plane 5, splits the optical path, folds the intermediate image plane 5 at a position that does not overlap the optical path that passes through the beam splitter 64, the other optical paths, and other optical elements, and forms a separate intermediate image (another intermediate image). In addition, a light receiver 11 is disposed such that the light receiving surface 11a is positioned on the image plane thereof. Depending on necessity, the light receiver 11 disposed here can be a different type of element that the light receiver 11 disposed at the image plane that passes through the exit pupil 7.

According to this modification, because the reflecting surface 23a is disposed at a position substantially overlapping the exit pupil 7, even in the case that the incident field angle of the incident light beam 51 is large, there is almost no movement of the light beam on the reflecting surface 23a, it is possible to make the effective diameter of the reflecting surface 23a small, and thereby it is possible to make a compact and inexpensive decentered optical system.

In this manner, because the reflecting surface 23a is comparatively small, when a rotatable reflecting surface such as a galvano-mirror is used as the reflecting mirror 23, there is the advantage that high-speed deflection is possible.

In addition, because an intermediate image whose aberration has been advantageously corrected by the beam splitter 64 is received on the light receiver 11, it is possible to obtain a high resolution received image in addition to the received image at the light receiving surface 11a on the reflecting mirror 23 side, and thus there is the advantage that the plurality of received images can be used for multiple purposes.

Third Modification

The third modification of the decentered optical system 1 will now be explained.

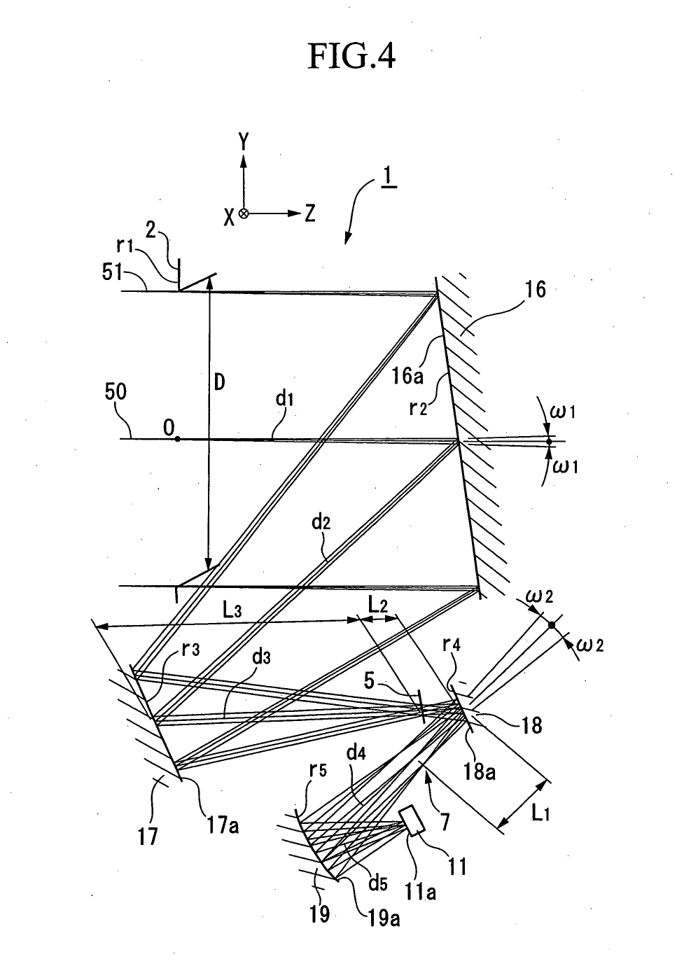

FIG. 4 is a cross-sectional optical path diagram that includes the optical path of an axial principal ray for explaining the third modification of the present embodiment.

Instead of the reflecting mirrors 3, 4, and 6 and the focusing device 10 of the embodiment described above, this modification provides a reflecting optical element 16 (first optical element), a reflecting mirror 17 (second optical element), a reflecting mirror 18 (third optical element), and a reflecting mirror 19 (focusing device). Here, the coefficients of the free-formed surface and the amount of decentration of the reflecting surface 17a (decentered reflecting surface) and the reflecting surface 18a (optically active surface having a positive power) of the reflecting mirrors 17 and 18 differ only slightly from the corresponding reflecting surfaces 4a and 6a, and have substantially identical functions. Thus, their explanation is omitted. Similarly, the reflecting mirror 19 having a reflecting surface 19a consisting of a rotationally asymmetric surface has a function substantially identical to that of the reflecting mirror 15 in the first modification, and thus its explanation is omitted.

The reflecting optical element 16 provides a Fresnel reflecting surface 16a having a positive power, and is disposed decentered in the positive direction around the X-axis. The Fresnel reflecting surface 16a preferably employs a structure equivalent to an axially symmetric aspheric surface in order to decrease the aberration while mainly imparting the power to the decentered optical system 1.

According to this modification, in the decentered optical system 1, because a reflecting optical element 16 providing a Fresnel reflecting surface 16a is used as the first optical element, which has the largest opening diameter, it is possible to make the first optical element light and thin. Therefore, there is the advantage that even when the entrance pupil diameter is large, it is possible to form a lightweight and comparatively small scale decentered optical system.

Fourth Modification

The fourth modification of the decentered optical system 1 will now be explained.

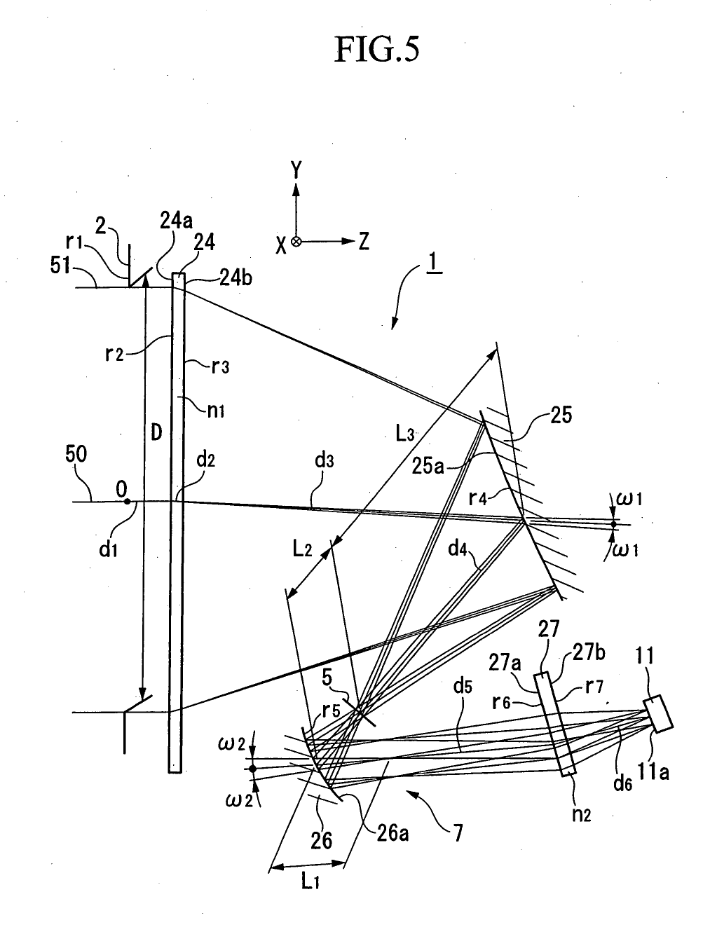

FIG. 5 is a cross-sectional optical path diagram that includes the optical path of the axial principal ray for explaining the fourth modification of the present embodiment.

Instead of the reflecting mirrors 3, 4, and 6 and the focusing device 10 of the embodiment described above, the present modification provides a Fresnel lens 24 (first optical element), a reflecting mirror 25 (second optical element), a reflecting mirror 36 (third optical element), and a Fresnel lens 27 (focusing device). Here, the coefficients of the free-formed surface and the amount of decentration of the reflecting surface 25a (decentered reflecting surface) differ only slightly from the corresponding reflecting surface 4a, and has a substantially identical effect. Thus, its explanation is omitted. Similarly, a reflecting mirror 26 having a reflecting surface 26a consisting of a rotationally asymmetric surface has a function substantially identical to the reflecting mirror of the first modification, and thus its explanation has been omitted.

The Fresnel lens 24 is a substantially flat plate shaped transmitting optical element that provides from the object side a Fresnel lens surface 24a having a positive power and a flat surface 24b for guiding the incident light beam 51 backwards as convergent light. In addition, the Fresnel lens surface 24a is formed equivalent to an axially symmetric aspheric surface and is disposed decentered in the negative direction of the Y-axis direction in order to decrease the occurrence of aberration due to the reflective mirrors 25 and 26, which are decentered reflecting surfaces on the image side.

The Fresnel lens 27 is a flat plate shaped transmitting optical element providing from the object side a Fresnel lens surface 27a having a positive power and a plane surface 27b. In addition, the Fresnel lens surface 24a is formed equivalent to an axially aspheric surface and is disposed decentered in the positive direction around the X-axis.

According to this modification, because a Fresnel lens 24 providing the Fresnel lens surface 24a is used as the first optical element having the largest opening diameter, it is possible for the first optical element to be made light weight and thin. Therefore, even when the entrance pupil is large, there is the advantage that it is possible to form a light weight and small-scale decentered optical system.

In addition, according to this modification, because the Fresnel lens 24 is tilted with respect to the axially principal ray 50, there are the advantages that it is possible to reduce drastically the aberration correction burden of the reflecting mirrors 25 and 26 on the image side and a superior image forming capacity can be imparted to the decentered optical system 1.

In this modification, the number of folds is comparatively small and a thin Fresnel lens 24 can have imparted a large positive power, and thus, as shown in FIG. 5, it is possible to open a comparatively large triangular space in the direction of the light beam that travels through the Fresnel lens 24 towards the reflecting mirror 25. Therefore, it is possible to compactly fold the optical path by using this space.

In addition, because the Fresnel lens 27 is used as the focusing device, a comparatively large effective diameter can be easily formed, and thus there is the advantage that even when the incident field angle is large, focusing can be carried out easily.

Fifth Modification

The fifth modification of the decentered optical system 1 will now be explained.

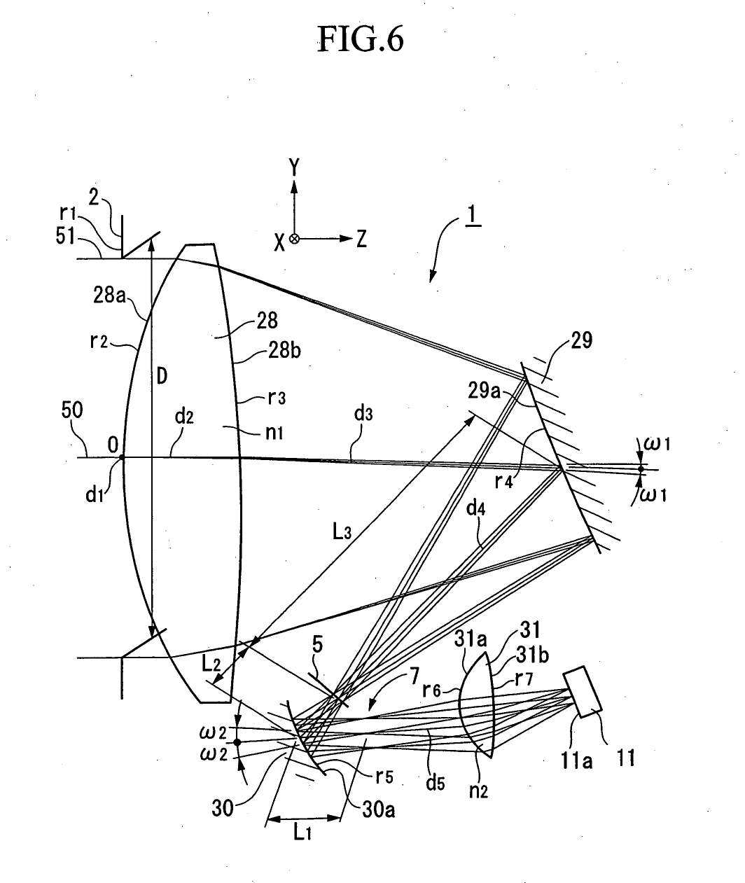

FIG. 6 is a cross-sectional optical path diagram that includes the optical path on the axial principal ray for explaining the fifth modification of the present embodiment.

Instead of the reflecting mirrors 3, 4, and 6 and the focusing device 10 in the embodiment described above, the present modification provides a lens 28 (first optical element), a reflecting mirror 29 (second optical element) a reflecting mirror 30 (third optical element), and a lens 31 (focusing device). In addition, instead of the Fresnel lenses 24 and 27 in the fourth modification, the configuration is substantially identical to one providing the lenses 28 and 31.

The coefficients of the free-formed surface of the reflecting surface and the amount of decentration of reflecting mirror 29 having the reflecting surface 29a (decentered active surface) and the reflecting mirror 30 having the reflecting surface 30a (an optically active surface having a positive power) correspond to the reflecting mirrors 25 and 26 of the fourth modification, and they have substantially identical functions. Thus, their explanation has been omitted.

The lens 28 provides from the object side a convex surface 28a and a convex surface 28b for guiding the incident light beam 51 backwards as converged light, and is an axially symmetrical lens having a positive power. In addition, the lens 28 is positioned slightly decentered in order to decease the occurrence of aberration due to the reflecting mirrors 29 and 30, which are downstream decentered reflecting surfaces.

The lens 31 provides from the object side convex surface 31a and convex surface 31b for focusing the substantially parallel light beam emitted from the exit pupil 7 onto the light receiving surface 11a, and is an axially symmetrical lens having a positive power.

Note that in order to decrease aberration further and make fabrication of the surface shapes of the reflecting mirrors 29 and 30 simple, at least one among the optical active surfaces of the lenses 28 and 31 is preferably a rotationally symmetric aspheric surface.

According to this modification, in the decentered optical system 1, because the lens 28, which is an axially symmetric lens, is used as the first optical element, which has the largest opening diameter, and the lens 31, which is an axially symmetric lens, is used as the focusing device, the complex surface shapes in the decentered optical system 1 are decreased, the manufacture becomes simple, and an inexpensive optical system can be formed.

Furthermore, when the axially symmetric aspheric surface is used in the lenses 28 and 31, it is possible to improve the aberration without increasing the number of lenses, and it is possible to form an inexpensive optical system having a superior image forming capacity.

Sixth Modification

The sixth modification of the decentered optical system 1 will be explained.

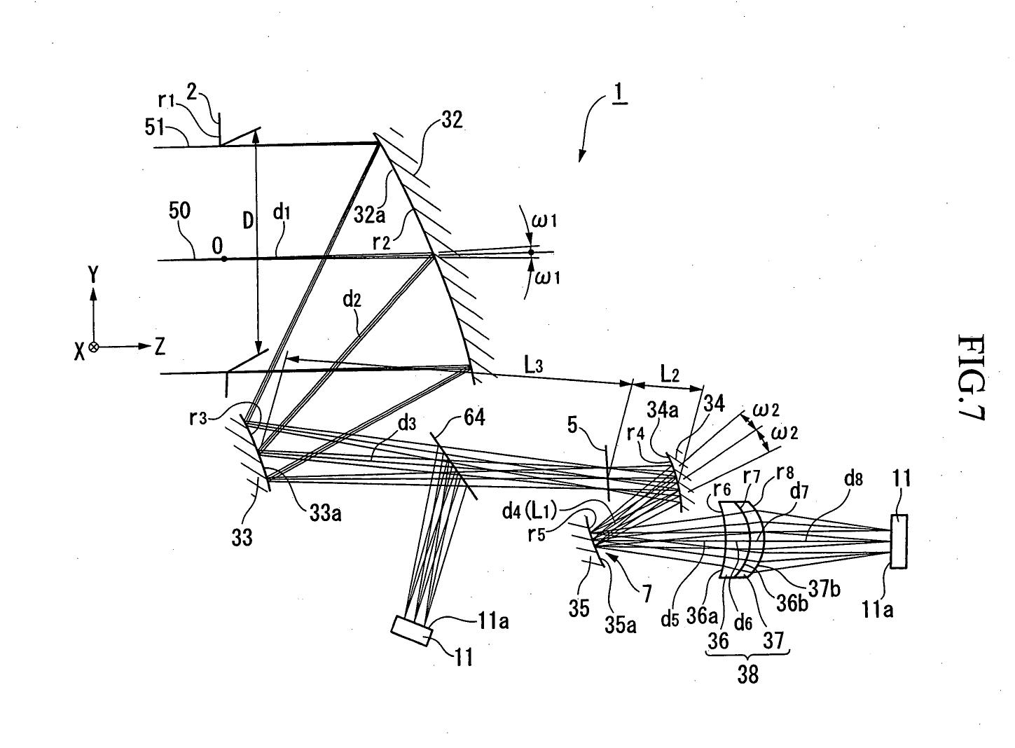

FIG. 7 is a cross-sectional optical path diagram that includes the optical path of the axial principal ray in order to explain the sixth modification of the present embodiment.

Instead of the reflecting mirrors 3, 4, and 6 and the focusing device 10 of the embodiment described above, this modification provides a reflecting mirror 32 (first optical element), a reflecting mirror 33 (second optical element), a reflecting mirror 34 (third optical element), and a focusing device 38, and further adds a beam splitter 64 (second optical path splitting device) and a movable reflecting element 35 (optical deflecting device). Here, the coefficients of the free-formed surface and the amount of decentration of the reflecting surface 32a and the reflecting surface 33a (decentered reflecting surface) and the reflecting surface 34a (optically active surface having a positive power) of the reflecting mirrors 32, 33 and 34 differ only slightly from the corresponding the reflecting surfaces 3a, 4a, and 6a, and have substantially identical functions. Thus, their explanation is omitted.

Like the second modification, the beam splitter 64 is disposed between the second optical element and the intermediate image plane 5, and forms one more intermediate image (another intermediate image) at the light receiving surface 11a of the added light receiver 1.

The movable reflecting element 35 is an optical element that provides a planar reflecting surface 35a that can move in the 2-axis direction, and, for example, a galvano-mirror that is activated by a suitable rotation driving device such as an actuator, optical MEMS (micro electro mechanical systems) or the like can be used. In addition, the reflecting surface 35a is disposed at a position that approximately overlaps the exit pupil 7 formed on the image side of the rotatable reflecting mirror 34.

The focusing device 38 consists of a lens 36 and lens 37. The lens 36 is an axially symmetric lens having a positive power that provides a concave surface 36a having an aspheric shape and a convex lens 36b on the image side. The lens 37 is a spherical lens having a positive power that provides from the object side a concave surface 37a and a convex surface 37b.

According to this modification, the substantially parallel light beam reflected reflecting mirror 34 is decentered by the movable reflecting element 35, and the image formation position on the light receiving surface 11a can be varied. As a result, even if the incident field view of the incident light beam 51 changes, by changing the field angle of the movable reflecting element 35 depending on the incident field angle, it is possible to maintain a steady received image on the light receiving surface 11a.

Note that in the explanation of the first embodiment and the modifications thereof, an example in which the first optical element comprises a light reflecting element, a Fresnel lens, and an axially symmetrical lens was explained, but any optical element can be used if it has a positive power. For example, a reflecting optical element having a reflecting diffraction grating surface or a transmitting diffraction grating can be used. Thereby, it is possible to make a thin optical element similar to a Fresnel lens, and thus there is the advantage that a compact decentered optical system becomes possible.

In addition, in the fourth modification of the first embodiment, an example in which a first optical element consisting of a Fresnel lens was disposed decentered in the Y-axis direction, but of course depending on the structure of the Fresnel lens surface and the disposition of each of the optical elements, the first optical element can be decentered around the X-axis.

In addition, in the explanation of the first embodiment and the modifications thereof, an example was explained wherein a rotationally asymmetric free-formed surface and a Fresnel reflecting surface were used as the rotationally asymmetric decentered reflecting surface of the second optical element, but, for example, this can also be formed by a reflecting diffraction grating surface or the like.

In addition, in the explanation of the first embodiment and the modifications thereof, an example was explained wherein a rotationally asymmetric free-formed surface was used as the optically active surface of the third optical element, this optically active surface having a positive power, but, for example, a reflecting diffraction grating surface and a Fresnel reflecting surface or the like can also be used as the other reflecting optical element.

In addition, in the explanation of the first embodiment and the modifications thereof, an example was explained wherein a decentered reflecting surface using a rotationally asymmetric free-formed surface, a concave surface reflecting mirror, a Fresnel lens, and an axially symmetric lens were used as a focusing device, but if the focusing device has an optically active surface providing a positive power, then, for example, a Fresnel reflecting surface or a transmitting or reflecting refraction grating can be provided. Furthermore, the focusing device can be formed by an optical system that combines the optical element and the optically active surface thereof.

### EXAMPLE 1

Next, a first numerical example of the decentered optical system of the first embodiment explained above will be explained with reference to FIG. 1.

Below, the structural parameters of the optical system of the first numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and the like have been explained above, and thus their explanation has been omitted. The angles α, β, and γ shown in the table of decentrations show the angle of the direction that has been explained above as the direction of the tilt angle. The unit of length is mm and the unit for angles is degrees (°) In addition, the origin of the decentration and the center of rotation are appropriately noted in the data.

In addition, a free-formed surface (FFS surface) and an aspheric surface are described by the equation (a) above. Note that the term related to the free-formed surface and the aspheric surface not shown in the data are 0.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | FFS[1] | d₂ = 0.00 | decentration [2] | | |
| 3 | FFS[2] | d₃ = 0.00 | decentration [3] | | |
| 4 | FFS[3] | d₄ = 0.00 | decentration [4] | | |
| 5 | r₅ = 22.28 | d₅ = 0.00 | decentration [5] | n₁ = 1.5163 | ν₁ = 64.1 |
| 6 | r₆ = 11.80 | d₆ = 0.00 | decentration [6] | | |
| 7 | r₇ = −11.92 | d₇ = 0.00 | decentration [7] | n₂ = 1.5163 | ν₂ = 64.1 |
| 8 | r₈ = −240.60 | d₈ = 0.00 | decentration [8] | | |
| image | ∞ | d₉ = 0.00 | decentration [9] | | |
| plane | | | | | |

FFS[1]

| | | | | | |
|---|---|---|---|---|---|
| C₄ | −3.4565 × 10⁻³ | C₆ | −3.1498 × 10⁻³ | C₈ | 8.4928 × 10⁻⁶ |
| C₁₀ | 8.5602 × 10⁻⁶ | C₁₁ | −1.6152 × 10⁻⁸ | C₁₃ | −5.4091 × 10⁻⁸ |
| C₁₅ | −3.2260 × 10⁻⁸ | | | | |

FFS[2]

| | | | | | |
|---|---|---|---|---|---|
| C₄ | −7.7515 × 10⁻³ | C₆ | −8.0107 × 10⁻³ | C₈ | 1.7771 × 10⁻⁴ |
| C₁₀ | 2.3411 × 10⁻⁴ | C₁₁ | −1.2274 × 10⁻⁶ | C₁₃ | −7.8534 × 10⁻⁶ |
| C₁₅ | −6.2261 × 10⁻⁶ | | | | |

FFS[3]

| | | | | | |
|---|---|---|---|---|---|
| C₄ | −2.0751 × 10⁻² | C₆ | −2.0236 × 10⁻² | C₈ | −1.3227 × 10⁻⁴ |
| C₁₀ | 9.0977 × 10⁻⁵ | C₁₁ | 8.9802 × 10⁻⁶ | C₁₃ | 2.5363 × 10⁻⁵ |
| C₁₅ | 1.0752 × 10⁻⁵ | | | | |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | 0.00 | Z | 50.00 |
| α | 19.45 | β | 0.00 | γ | 0.00 |

decentration [3]

| | | | | | |
|---|---|---|---|---|---|
| X | 0.00 | Y | −35.84 | Z | 4.84 |
| α | 18.82 | β | 0.00 | γ | 0.00 |

decentration [4]

| | | | | | |
|---|---|---|---|---|---|
| X | 0.00 | Y | −38.00 | Z | 60.38 |
| α | 15.35 | β | 0.00 | γ | 0.00 |

decentration [5]

| | | | | | |
|---|---|---|---|---|---|
| X | 0.00 | Y | −54.13 | Z | 36.33 |
| α | 30.64 | β | 0.00 | γ | 0.00 |

decentration [6]

| | | | | | |
|---|---|---|---|---|---|
| X | 0.00 | Y | −56.43 | Z | 32.43 |
| α | 30.64 | β | 0.00 | γ | 0.00 |

decentration [7]

| | | | | | |
|---|---|---|---|---|---|
| X | 0.00 | Y | −56.57 | Z | 32.06 |
| α | 30.76 | β | 0.00 | γ | 0.00 |

decentration [8]

| | | | | | |
|---|---|---|---|---|---|
| X | 0.00 | Y | −57.64 | Z | 30.27 |
| α | 30.76 | β | 0.00 | γ | 0.00 |

decentration [7]

| | | | | | |
|---|---|---|---|---|---|
| X | 0.00 | Y | −64.61 | Z | 18.55 |
| α | 30.76 | β | 0.00 | γ | 0.00 |

### EXAMPLE 2

Next, a second numerical example that corresponds to the first modification of the decentered optical system of the first embodiment explained above will be explained with reference to FIG. 2.

Below, the structural parameters of the optical system of the second numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and other aspects are identical to those of example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | FFS[1] | d₂ = 0.00 | decentration [2] | | |
| 3 | FFS[2] | d₃ = 0.00 | decentration [3] | | |
| 4 | FFS[3] | d₄ = 0.00 | decentration [4] | | |
| 5 | FFS[4] | d₅ = 0.00 | decentration [5] | | |
| image | ∞ | d₆ = 0.00 | decentration [6] | | |
| plane | | | | | |

FFS[1]

| | | | | | |
|---|---|---|---|---|---|
| C₄ | −3.4445 × 10⁻³ | C₆ | −3.1420 × 10⁻³ | C₈ | 1.1200 × 10⁻⁵ |
| C₁₀ | 8.7510 × 10⁻⁶ | C₁₁ | −1.3413 × 10⁻⁸ | C₁₃ | −4.2606 × 10⁻⁸ |
| C₁₅ | −2.9969 × 10⁻⁸ | | | | |

FFS[2]

| | | | | | |
|---|---|---|---|---|---|
| C₄ | −8.0456 × 10⁻³ | C₆ | −7.7520 × 10⁻³ | C₈ | 3.5328 × 10⁻⁴ |
| C₁₀ | 2.5165 × 10⁻⁴ | C₁₁ | −1.4770 × 10⁻⁶ | C₁₃ | −9.7767 × 10⁻⁶ |
| C₁₅ | −6.2066 × 10⁻⁶ | | | | |

FFS[3]

| | | | | | |
|---|---|---|---|---|---|
| C₄ | −2.2965 × 10⁻² | C₆ | −1.6374 × 10⁻² | C₈ | 4.0504 × 10⁻⁴ |
| C₁₀ | 1.9625 × 10⁻⁵ | C₁₁ | 1.1474 × 10⁻⁵ | C₁₃ | 4.2375 × 10⁻⁶ |
| C₁₅ | 1.3904 × 10⁻⁶ | | | | |

FFS[4]

| | | | | | |
|---|---|---|---|---|---|
| C₄ | 2.1334 × 10⁻² | C₆ | 1.8909 × 10⁻² | C₈ | −1.2603 × 10⁻⁵ |
| C₁₁ | 1.5782 × 10⁻⁵ | C₁₃ | 2.6438 × 10⁻⁵ | C₁₅ | 1.2056 × 10⁻⁵ |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | 0.00 | Z | 50.00 |
| α | 19.45 | β | 0.00 | γ | 0.00 |

decentration [3]

| | | | | | |
|---|---|---|---|---|---|
| X | 0.00 | Y | −35.83 | Z | 4.79 |
| α | 18.80 | β | 0.00 | γ | 0.00 |

decentration [4]

| | | | | | |
|---|---|---|---|---|---|
| X | 0.00 | Y | −37.88 | Z | 62.47 |
| α | 15.14 | β | 0.00 | γ | 0.00 |

decentration [5]

| | | | | | |
|---|---|---|---|---|---|
| X | 0.00 | Y | −60.36 | Z | 22.75 |
| α | 9.50 | β | 0.00 | γ | 0.00 |

decentration [6]

| | | | | | |
|---|---|---|---|---|---|
| X | 0.00 | Y | −62.70 | Z | 35.12 |
| α | 7.21 | β | 0.00 | γ | 0.00 |

### EXAMPLE 3

Next, a third numerical example that corresponds to the second modification of the decentered optical system of the first embodiment explained above will be explained with reference to FIG. 3. However, the beam splitter 64 and the optical path after the beam splitting have been omitted.

Below, the structural parameters of the optical system of the third numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and other aspects are identical to those of example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | FFS[1] | d₂ = 0.00 | decentration [2] | | |
| 3 | FFS[2] | d₃ = 0.00 | decentration [3] | | |
| 4 | FFS[3] | d₄ = 0.00 | decentration [4] | | |
| 5 | r₅ = 20.00 | d₅ = 0.00 | decentration [5] | | |
| image | ∞ | d₆ = 0.00 | decentration [6] | | |
| plane | | | | | |

FFS[1]

| | | | | | |
|---|---|---|---|---|---|
| C₄ | −3.4584 × 10⁻³ | C₆ | −3.1500 × 10⁻³ | C₈ | 9.7123 × 10⁻⁶ |
| C₁₀ | 8.5861 × 10⁻⁶ | C₁₁ | −3.6494 × 10⁻⁹ | C₁₃ | −3.3216 × 10⁻⁸ |
| C₁₅ | −2.6496 × 10⁻⁸ | | | | |

FFS[2]

| | | | | | |
|---|---|---|---|---|---|
| C₄ | −9.4480 × 10⁻³ | C₆ | −1.0277 × 10⁻² | C₈ | 2.8210 × 10⁻⁴ |
| C₁₀ | 2.7905 × 10⁻⁴ | C₁₁ | 2.7043 × 10⁻⁶ | C₁₃ | −8.9652 × 10⁻⁷ |
| C₁₅ | −3.5419 × 10⁻⁶ | | | | |

FFS[3]

| | | | | | |
|---|---|---|---|---|---|
| C₄ | −8.0000 × 10⁻³ | C₆ | −2.5000 × 10⁻² | C₈ | 7.6349 × 10⁻⁶ |
| C₁₀ | 6.9523 × 10⁻⁶ | C₁₁ | −5.0026 × 10⁻⁹ | C₁₃ | −2.6722 × 10⁻⁸ |
| C₁₅ | −2.0066 × 10⁻⁸ | | | | |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | 0.00 | Z | 40.00 |
| α | 21.50 | β | 0.00 | γ | 0.00 |

decentration [3]

| | | | | | |
|---|---|---|---|---|---|
| X | 0.00 | Y | −41.05 | Z | −3.74 |
| α | 14.00 | β | 0.00 | γ | 0.00 |

decentration [4]

| | | | | | |
|---|---|---|---|---|---|
| X | 0.00 | Y | −48.00 | Z | 45.00 |
| α | −30.00 | β | 0.00 | γ | 0.00 |

decentration [5]

| | | | | | |
|---|---|---|---|---|---|
| X | 0.00 | Y | −40.00 | Z | 39.00 |
| α | −42.00 | β | 0.00 | γ | 0.00 |

decentration [6]

| | | | | | |
|---|---|---|---|---|---|
| X | 0.00 | Y | −41.00 | Z | 48.00 |
| α | −10.00 | β | 0.00 | γ | 0.00 |

### EXAMPLE 4

Next, a fourth numerical example that corresponds to the third modification of the decentered optical system of the first embodiment explained above will be explained with reference to FIG. 4.

Below, the structural parameters of the optical system of the fourth numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and other aspects are identical to those in example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | aspheric [1] | d₂ = 0.00 | decentration [2] | | |
| | surface | | | | |
| 3 | FFS[1] | d₃ = 0.00 | decentration [3] | | |
| 4 | FFS[2] | d₄ = 0.00 | decentration [4] | | |
| 5 | FFS[3] | d₅ = 0.00 | decentration [5] | | |
| Image | ∞ | d₆ = 0.00 | decentration [6] | | |
| plane | | | | | |

Aspheric surface [1]

Radius of curvature −178.78

| | | | | | |
|---|---|---|---|---|---|
| k | −1.3797 | | | | |
| a | 3.7354 × 10⁻⁸ | b | 5.1860 × 10⁻¹² | c | −1.0439 × 10⁻¹⁵ |
| d | 5.7655 × 10⁻²⁰ | | | | |

FFS[1]

| | | | | | |
|---|---|---|---|---|---|
| C₄ | −1.0000 × 10⁻⁴ | C₆ | −4.1155 × 10⁻⁴ | C₈ | 3.6284 × 10⁻⁵ |
| C₁₀ | 6.1162 × 10⁻⁵ | C₁₁ | 6.6278 × 10⁻⁷ | C₁₃ | 1.0134 × 10⁻⁶ |
| C₁₅ | −7.9098 × 10⁻⁷ | | | | |

FFS[2]

| | | | | | |
|---|---|---|---|---|---|
| C₄ | −2.4214 × 10⁻² | C₆ | −2.1601 × 10⁻² | C₈ | −2.9038 × 10⁻⁴ |
| C₁₀ | 1.4476 × 10⁻⁴ | C₁₁ | −3.8953 × 10⁻⁵ | C₁₃ | −2.1604 × 10⁻⁵ |
| C₁₅ | −2.8220 × 10⁻⁵ | | | | |

FFS[3]

| | | | | | |
|---|---|---|---|---|---|
| C₄ | 2.2678 × 10⁻² | C₆ | 2.0633 × 10⁻² | C₈ | −7.2914 × 10⁻⁵ |
| C₁₁ | 1.3389 × 10⁻⁵ | C₁₃ | 2.6948 × 10⁻⁵ | C₁₅ | 1.7910 × 10⁻⁵ |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | −52.00 | Z | 52.06 |
| α | 7.74 | β | 0.00 | γ | 0.00 |

decentration [3]

| | | | | | |
|---|---|---|---|---|---|
| X | 0.00 | Y | −49.82 | Z | −2.37 |
| α | 23.77 | β | 0.00 | γ | 0.00 |

decentration [4]

| | | | | | |
|---|---|---|---|---|---|
| X | 0.00 | Y | −45.40 | Z | 46.00 |
| α | 25.00 | β | 0.00 | γ | 0.00 |

decentration [5]

| | | | | | |
|---|---|---|---|---|---|
| X | 0.00 | Y | −67.38 | Z | 21.19 |
| α | 25.65 | β | 0.00 | γ | 0.00 |

decentration [6]

| | | | | | |
|---|---|---|---|---|---|
| X | 0.00 | Y | −65.00 | Z | 36.80 |
| α | 28.10 | β | 0.00 | γ | 0.00 |

### EXAMPLE 5

Next, a fifth numerical example that corresponds to the fourth modification of the decentered optical system of the first embodiment explained above will be explained with reference to FIG. 5.

Below, the structural parameters of the optical system of the first numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and other aspects are identical to those of example 1.

| surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | aspheric | d₂ = 0.00 | decentration [2] | n₁ = 1.5254 | ν₁ = 56.2 |
| | surface [1] | | | | |
| 3 | r₃ = ∞ | d₃ = 0.00 | decentration [3] | | |
| 4 | FFS[1] | d₄ = 0.00 | decentration [4] | | |
| 5 | FFS[2] | d₅ = 0.00 | decentration [5] | | |
| 6 | aspheric | d₆ = 0.00 | decentration [6] | n₂ = 1.5168 | ν₂ = 64.1 |
| | surface [2] | | | | |
| 7 | r₇ = ∞ | d₇ = 0.00 | decentration [7] | | |
| image | ∞ | d₈ = 0.00 | decentration [8] | | |
| plane | | | | | |

Aspheric surface [1]

| Radius of curvature 33.71 | | | | | |
|---|---|---|---|---|---|
| k | −5.9100 × 10⁻¹ | | | | |
| a | −1.0496 × 10⁻⁶ | b | −3.6753 × 10⁻¹⁰ | c | 9.4791 × 10⁻¹⁴ |
| d | −1.0419 × 10⁻¹⁶ | | | | |

aspheric surface [2]

| radius of curvature 5.96 | | | | | |
|---|---|---|---|---|---|
| k | −9.6545 × 10⁻¹ | a | −1.4690 × 10⁻⁴ | b | 1.1461 × 10⁻⁶ |

FFS[1]

| | | | | | |
|---|---|---|---|---|---|
| C₄ | 2.5206 × 10⁻³ | C₆ | 2.4189 × 10⁻³ | C₈ | −3.0177 × 10⁻⁵ |
| C₁₀ | −2.9906 × 10⁻⁵ | C₁₁ | −5.0891 × 10⁻⁷ | C₁₃ | −2.6831 × 10⁻⁷ |
| C₁₅ | 8.6656 × 10⁻⁸ | | | | |

FFS[2]

| | | | | | |
|---|---|---|---|---|---|
| C₄ | 3.5051 × 10⁻² | C₆ | 3.0118 × 10⁻² | C₈ | 6.2780 × 10⁻⁴ |
| C₁₀ | 3.2736 × 10⁻⁴ | C₁₁ | 4.9327 × 10⁻⁵ | C₁₃ | 1.0494 × 10⁻⁵ |
| C₁₅ | 5.5098 × 10⁻⁵ | | | | |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | −2.79 | Z | 5.00 |
| α | 0.00 | β | 0.00 | γ | 0.00 |

decentration [3]

| | | | | | |
|---|---|---|---|---|---|
| X | 0.00 | Y | −2.79 | Z | 6.50 |
| α | 0.00 | β | 0.00 | γ | 0.00 |

decentration [4]

| | | | | | |
|---|---|---|---|---|---|
| X | 0.00 | Y | −7.61 | Z | 49.17 |
| α | 25.52 | β | 0.00 | γ | 0.00 |

decentration [5]

| | | | | | |
|---|---|---|---|---|---|
| X | 0.00 | Y | −31.41 | Z | 22.53 |
| α | 29.71 | β | 0.00 | γ | 0.00 |

decentration [6]

| | | | | | |
|---|---|---|---|---|---|
| X | 0.00 | Y | −26.16 | Z | 49.54 |
| α | 16.17 | β | 0.00 | γ | 0.00 |

decentration [7]

| | | | | | |
|---|---|---|---|---|---|
| X | 0.00 | Y | −25.75 | Z | 50.98 |
| α | 16.17 | β | 0.00 | γ | 0.00 |

decentration [8]

| | | | | | |
|---|---|---|---|---|---|
| X | 0.00 | Y | −25.00 | Z | 61.18 |
| α | 22.31 | β | 0.00 | γ | 0.00 |

### EXAMPLE 6

Next, a sixth numerical example that corresponds to the fifth modification of the decentered optical system of the first embodiment explained above will be explained with reference FIG. 6.

Below, the structural parameters of the optical system of the first numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and other aspects are identical to example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | r₂ = 51.96 | d₂ = 0.00 | decentration [2] | n₁ = 1.5168 | ν₁ = 64.1 |
| 3 | aspheric | d₂ = 0.00 | decentration [3] | | |
| | surface [1] | | | | |
| 4 | FFS[1] | d₄ = 0.00 | decentration [4] | | |
| 5 | FFS[2] | d₅ = 0.00 | decentration [5] | | |
| 6 | aspheric | d₆ = 0.00 | decentration [6] | n₂ = 1.5168 | ν₂ = 64.1 |
| | surface [2] | | | | |
| 7 | r₇ = −35.95 | d₇ = 0.00 | decentration [7] | | |
| image | ∞ | d₈ = 0.00 | decentration [8] | | |
| plane | | | | | |

Aspheric surface [1]

| Radius of curvature −139.04 | | | | | |
|---|---|---|---|---|---|
| k | −9.3051 | | | | |
| a | 1.3554 × 10⁻⁶ | b | −4.7420 × 10⁻¹⁰ | c | 2.6757 × 10⁻¹³ |
| d | −1.1049 × 10⁻¹⁶ | | | | |

Aspheric surface [2]

| Radius of curvature 6.02 | | | |
|---|---|---|---|
| k | −7.1141 × 10⁻¹ | | |
| a | −5.4410 × 10⁻⁵ | b | −3.0638 × 10⁻⁶ |

FFS[1]

| | | | | | |
|---|---|---|---|---|---|
| C₄ | 2.7083 × 10⁻³ | C₆ | 2.3787 × 10⁻³ | C₈ | −2.9926 × 10⁻⁶ |
| C₁₀ | −3.8151 × 10⁻⁶ | C₁₁ | −1.2402 × 10⁻⁶ | C₁₃ | −2.0407 × 10⁻⁶ |
| C₁₅ | −7.8917 × 10⁻⁷ | | | | |

FFS[2]

| | | | | | |
|---|---|---|---|---|---|
| C₄ | 3.5091 × 10⁻² | C₆ | 3.1268 × 10⁻² | C₈ | 6.1310 × 10⁻⁴ |
| C₁₀ | −1.3447 × 10⁻⁴ | C₁₁ | 3.5660 × 10⁻⁵ | C₁₃ | 5.9244 × 10⁻⁶ |
| C₁₅ | −2.9029 × 10⁻⁵ | | | | |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | −2.34 | Z | 0.00 |
| α | 1.95 | β | 0.00 | γ | 0.00 |

decentration [3]

| | | | | | |
|---|---|---|---|---|---|
| X | 0.00 | Y | −1.84 | Z | 14.60 |
| α | 1.95 | β | 0.00 | γ | 0.00 |

decentration [4]

| | | | | | |
|---|---|---|---|---|---|
| X | 0.00 | Y | −4.58 | Z | 55.91 |
| α | 23.11 | β | 0.00 | γ | 0.00 |

decentration [5]

| | | | | | |
|---|---|---|---|---|---|
| X | 0.00 | Y | −33.31 | Z | 21.28 |
| α | 18.68 | β | 0.00 | γ | 0.00 |

decentration [6]

| | | | | | |
|---|---|---|---|---|---|
| X | 0.00 | Y | −31.05 | Z | 41.74 |
| α | 2.75 | β | 0.00 | γ | 0.00 |

decentration [7]

| | | | | | |
|---|---|---|---|---|---|
| X | 0.00 | Y | −30.84 | Z | 46.15 |
| α | 2.75 | β | 0.00 | γ | 0.00 |

decentration [8]

| | | | | | |
|---|---|---|---|---|---|
| X | 0.00 | Y | −29.72 | Z | 55.72 |
| α | 23.40 | β | 0.00 | γ | 0.00 |

### EXAMPLE 7

Next, a seventh numerical example that corresponds to the sixth modification of the decentered optical system of the first embodiment explained above will be explained with reference to FIG. 7.

Below, the structural parameters of the optical system of the first numerical example are shown. The terms rᵢ and nᵢ (i being an integer) shown in FIG. 1A correspond to rᵢ and nᵢ of the structural parameters of the optical system described below. In addition, the index of refraction is shown with respect to the line d (wavelength 587.56 nm).

The coordinate system and other aspects are identical to those of example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 0.00 | decentration [1] | | |
| 2 | FFS[1] | d₂ = 0.00 | decentration [2] | | |
| 3 | FFS[2] | d₃ = 0.00 | decentration [3] | | |
| 4 | FFS[3] | d₄ = 0.00 | decentration [4] | | |
| 5 | r₅ = ∞ | d₅ = 0.00 | decentration [5] | | |
| 6 | aspheric | d₂ = 0.00 | decentration [6] | n₁ = 1.6511 | ν₁ = 55.9 |
| | surface [1] | | | | |
| 7 | r₇ = −8.38 | d₇ = 0.00 | decentration [7] | n₂ = 1.8052 | ν₂ = 25.4 |
| 8 | r₈ = −9.75 | d₈ = 0.00 | decentration [8] | | |
| image | ∞ | d₉ = 0.00 | decentration [9] | | |
| plane | | | | | |

Aspheric surface [1]

Radius of curvature −38.79

| | | | |
|---|---|---|---|
| k | 0.0 | | |
| a | −2.3350 × 10⁻⁴ | | |
| b | −3.2133 × 10⁻⁶ | c | −2.1603 × 10⁻⁸ |

FFS[1]

| | | | | | |
|---|---|---|---|---|---|
| C₄ | −4.2294 × 10⁻³ | C₆ | −3.5737 × 10⁻³ | C₈ | 1.2894 × 10⁻⁵ |
| C₁₀ | 1.1408 × 10⁻⁵ | C₁₁ | −1.0632 × 10⁻⁸ | C₁₃ | −6.0602 × 10⁻⁸ |
| C₁₅ | −5.6990 × 10⁻⁸ | | | | |

FFS[2]

| | | | | | |
|---|---|---|---|---|---|
| C₄ | −1.3893 × 10⁻² | C₆ | −1.0747 × 10⁻² | C₈ | 2.4792 × 10⁻⁴ |
| C₁₀ | 2.2409 × 10⁻⁴ | C₁₁ | 2.7738 × 10⁻⁶ | C₁₃ | −1.2053 × 10⁻⁶ |
| C₁₅ | −6.3986 × 10⁻⁶ | | | | |

FFS[3]

| | | | | | |
|---|---|---|---|---|---|
| C₄ | −1.6959 × 10⁻² | C₆ | −1.4467 × 10⁻² | C₈ | 4.854 × 10⁻⁵ |
| C₁₀ | 2.4026 × 10⁻⁴ | C₁₁ | 7.9014 × 10⁻⁶ | C₁₃ | 2.5269 × 10⁻⁵ |
| C₁₅ | 1.9400 × 10⁻⁵ | | | | |

decentration [1]

| | | | | | |
|---|---|---|---|---|---|
| X | 0.00 | Y | 0.00 | Z | 0.00 |
| α | 0.00 | β | 0.00 | γ | 0.00 |

decentration [2]

| | | | | | |
|---|---|---|---|---|---|
| X | 0.00 | Y | 0.00 | Z | 40.00 |
| α | 22.57 | β | 0.00 | γ | 0.00 |

decentration [3]

| | | | | | |
|---|---|---|---|---|---|
| X | 0.00 | Y | −34.39 | Z | 5.53 |
| α | 20.17 | β | 0.00 | γ | 0.00 |

decentration [4]

| | | | | | |
|---|---|---|---|---|---|
| X | 0.33 | Y | −38.17 | Z | 83.98 |
| α | 19.31 | β | 0.00 | γ | 0.00 |

decentration [5]

| | | | | | |
|---|---|---|---|---|---|
| X | 0.33 | Y | −48.93 | Z | 68.08 |
| α | 14.15 | β | 0.00 | γ | 0.00 |

decentration [6]

| | | | | | |
|---|---|---|---|---|---|
| X | 0.34 | Y | −52.31 | Z | 93.95 |
| α | −1.91 | β | 0.00 | γ | 0.00 |

decentration [7]

| | | | | | |
|---|---|---|---|---|---|
| X | 0.34 | Y | −52.46 | Z | 98.45 |
| α | −1.91 | β | 0.00 | γ | 0.00 |

decentration [8]

| | | | | | |
|---|---|---|---|---|---|
| X | 0.34 | Y | −52.55 | Z | 100.94 |
| α | −1.91 | β | 0.00 | γ | 0.00 |

decentration [9]

| | | | | | |
|---|---|---|---|---|---|
| X | 0.34 | Y | −53.35 | Z | 124.93 |
| α | −1.91 | β | 0.00 | γ | 0.00 |

The calculated values related to the conditions of equations 1 through 6 in the examples 1 through 7 explained above are summarized below. Note that in all of the examples, the entrance pupil diameter D, the incident field angle ωₓ, and the incident field angle ω₁ in the perpendicular direction have the following values.

D=40 (mm), ωₓ=0.5 (°), ω₁=0.5 (°)

| Equation | unit | ex 1 | ex 2 | ex 3 | ex 4 | ex 5 | ex 6 | ex 7 |
|---|---|---|---|---|---|---|---|---|
| eq(1) | (°) | 0.35 | 0.51 | 5.61 | 6.81 | 1.53 | 1.78 | 0.76 |
| eq(2) | (mm) | 3.03 | 3.79 | 1.43 | 7.35 | 7.02 | 5.52 | 2.39 |
| eq(3) | | 0.29 | 0.35 | 0.31 | 0.22 | 0.17 | 0.17 | 0.47 |
| eq(4) | | 0.23 | 0.29 | 0.19 | 1.12 | 0.14 | 0.14 | 0.32 |
| eq(5) | | 0.88 | 0.86 | 0.98 | 0.86 | 0.61 | 0.80 | 1.69 |
| eq(6) | | 15.67 | 12.24 | 26.56 | 8.30 | 6.97 | 9.07 | 16.36 |

As can be understood from these results, all of the examples 1 through 7 satisfy the conditions of equations 1 through 6. In addition, they also satisfy the conditions of equations 1b through 6b, which have a narrower range.

As has been described above, according to the decentered optical system of the present invention, in an optical system in which the input light of a substantially parallel light beam incident at a field angle is focused onto at least one light receiving surface by using a rotationally asymmetric free-formed decentered reflecting surface, the effects are obtained that it is possible to prevent light loss due to obstruction before the input light reaches the light receiving surface, and it is possible to obtain a high performance decentered optical system that is small and wherein the light that forms an image on the light receiving surface has a high resolution power.

In addition, according to the light transmitting device, the light receiving device, and the optical system according to the present invention, the effect is obtained that it is possible to construct a light transmitting device, a light receiving device, and an optical system that can carry out high precision and high efficiency light capture and tracking by using a decentered optical system according to the present invention.

Third Embodiment

The decentered optical system according to the third embodiment of the present invention will be explained.

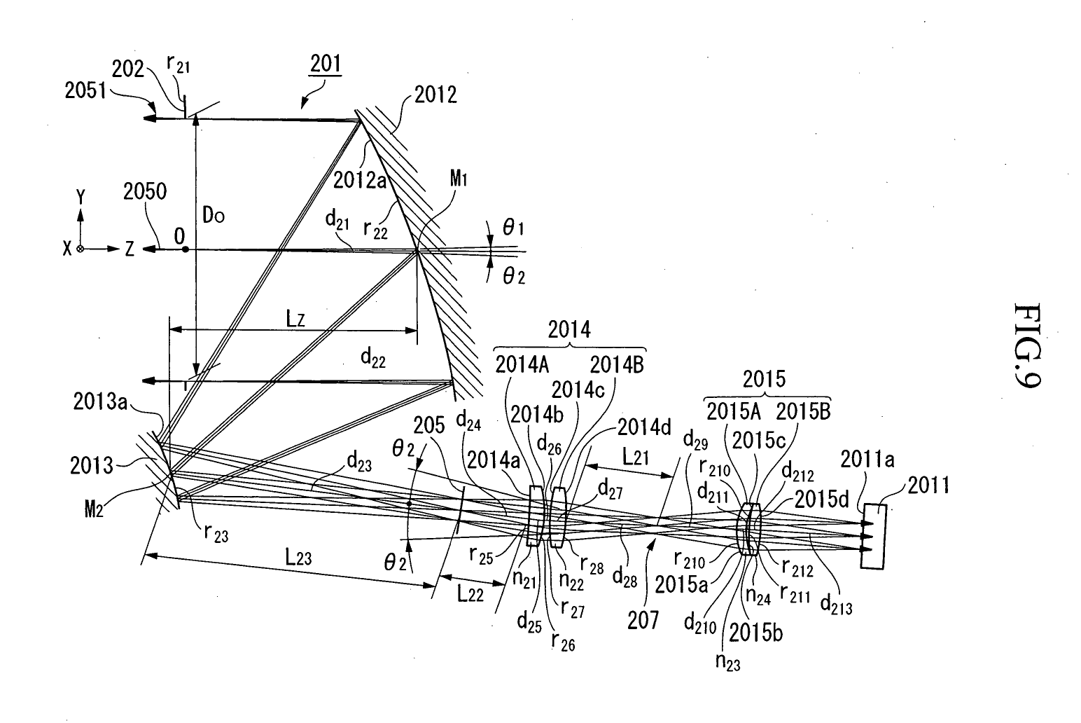

FIG. 9 is a cross-sectional optical path diagram that includes the optical path on an axial principal ray for explaining an example of the decentered optical system according to a third embodiment of the present invention. Note that when the optical path has an incident field angle of 0° and an incident field angle ±θ₁ around the axis perpendicular to the page surface, the light beam is traced by the principal ray and two characteristic rays.

The decentered optical system 201 according to a third embodiment of the present invention will be explained.

The decentered optical system 201 is for forming an image on a light receiving surface 2011a after a substantially parallel incident light beam 2051 (input light) is made incident on the system, and the schematic structure thereof consists of an aperture stop 202, a reflecting mirror 203 (first optical element), a reflecting mirror 204 (second optical element), a reflecting mirror 206 (third optical element), a focusing device 2010, and a light receiver 2011.

The aperture stop 202 is for restricting the light beam diameter of the incident light beam 2051, and serves as the entrance pupil of the decentered optical system 201. In the present embodiment, this aperture stop 202 is a round hole step having a diameter D. Among the principal rays, the axial principal ray 2050 passes through the center O of the aperture stop 202 and is then incident on the center of the light receiving surface. In addition, the optical path that is aligned with the axial principal ray serves as the optical axis.

Note that in the present embodiment, an incident field angle can be in a direction perpendicular to the page surface of the figure. However, in the following, in order to simplify the explanation, a two-dimensional in-plane optical path that includes the optical path of the axial principal ray 2050 will be explained, and the three-dimensional optical paths will be explained as necessary. The explanation of a two-dimensional optical path can easily be extended to the three-dimensional optical path.

The reflecting mirror 203 is an optical element for folding and focusing the optical path by reflecting the incident light beam 2051 that has passed through the aperture stop 202. The reflecting surface 203a is formed by a free-formed surface consisting of a rotationally asymmetric curved surface having a positive power. In addition, in order to guide the reflected light away from the incident light beam 2051 of the object, the reflecting surface 203a is disposed decentered counterclockwise (the positive direction around the X-axis of the coordinate system described below) when seen from the axis perpendicular to the page surface of the figure.

In addition to the normally occurring aberration, the shape of the reflecting surface 203a corrects the particular aberration caused by decentration that occurs due to the decentering of the reflecting surface 203a. Examples of such aberration are astigmatism and coma aberration on the axis, and bow and trapezoid shaped distortion (image distortion) particular to aberration caused by decentration and the like. Thus, preferably the reflecting surface 203a is a rotationally asymmetric curved surface such that only the plane (the Y-Z plane in the coordinate system described below) aligned with the page surface of the figure is a symmetric surface.

The reflecting mirror 203 serves as the optical element closest to the object side, and mainly imparts the power of the decentered optical system 201.

Here, the coordinate system for expressing the rotationally asymmetric surface and free form surface will be explained for the present embodiment.

As shown in FIG. 9, in the coordinate system, by tracing a ray from the object side towards the aperture stop 202 and the reflecting mirror 203, the incident optical axis is defined to be the light ray among the axial principal rays 2050 that is perpendicular to the center of the aperture stop 202 that forms the aperture surface and reaches the center of the transmitting surface 203 of the prism 201. In addition, in the ray tracing, the origin O of the decentered optical plane of the decentered optical system is defined as the center of the aperture stop 202 (where the illustrated coordinate axes are offset from the position of the origin point in order to avoid overlap with the optical path), and where the direction along the incident optical axis is defined as the Z-axis direction, the direction from the object towards the aperture stop 202 of the decentered optical system is defined as the positive Z-axis direction, the page surface defines the Y-Z plane, the direction from the surface to the back of the page is defined as the positive X-axis direction, and the axis that forms the right-handed rectangular coordinate system with respect to the X-axis and Z-axis is defined as the Y-axis.

Where the tilt angles centered on the X-axis, Y-axis, and Z-axis are denoted α, β, and γ, positive tilt angles α and β are defined by a clockwise rotation with respect to the positive direction of the X-axis and Y-axis, and the positive tilt angle γ is defined by a clockwise rotation with respect to the positive direction of the Z-axis.

In addition, when representing each of the optically active surfaces by a coordinate system, the axial principal ray 2050 is traced by a forward light ray in the direction from the object towards the image plane, and an optically active surface is represented by a local coordinate system rotated on the Y-axis and Z-axis such that the point where the optically active surface and the axial principal ray 2050 intersect is defined as the origin, and the Z-axis is aligned with the axial principal ray 2050 while maintaining the X-axis perpendicular to the page surface.

Note that when rotating α, β, and γ on the center axis of the plane, the center axis of the plane and the rectangular XYZ coordinate system thereof is rotated counterclockwise through an angle α around the X-axis; next, the center axis of this rotated surface is rotated counterclockwise through an angle β around the Y-axis of the new coordinate system; the coordinate system that has been rotated one time is also rotated counterclockwise through an angle β around the Y-axis; and next the center axis of the plane that has been rotated twice is rotated clockwise through an angle γ around the Z-axis of the new coordinate system.

The shape of the rotationally asymmetric spherical surface used in the present embodiment is represented, for example, by a free-form surface defined by the above equation (a). Since an explanation about the equation has been already made hereinbefore, it is omitted herein.

The reflecting mirror 204 is an optical element that reflects the light beam reflected by the reflecting mirror 4, and folds the optical path into a region that is not blocked by the reflecting mirror 203. At the same time, while correcting the aberrations caused by decentration, the reflecting mirror 204 forms the intermediate image at the intermediate image plane 205 at a predetermined position on the image side. Thereby, the reflecting surface 204a (decentered reflecting surface) is formed by a free-formed surface consisting of a rotationally asymmetric surface having a positive power, and is disposed decentered around the X-axis.

The reflecting surface 204a is shaped to correct not only normally occurring aberration, but also the particular aberration caused be decentration due to the decentering of the reflecting surface 203a, such as astigmatism and coma aberration that occur on the axis, and bow and trapezoid shaped distortions particular to aberration caused by decentration. In order to attain this, preferably the reflecting surface 204a is a rotationally asymmetric surface such that only the Y-Z plane is a symmetric surface.

The reflecting mirror 206 is an optical element that folds the light beam into a region in which it is not blocked by other optical elements after it has been reflected by the reflecting mirror 204 to form the intermediate image on the intermediate image plane 205. In addition, the reflecting mirror 206 focuses the light beam that diverges from the intermediate image plane 205 towards the image side to make a substantially parallel light beam. To attain this effect, the reflecting surface 206a (an optically active surface having a positive power) is formed by a free-formed surface consisting of a rotationally asymmetric surface having a positive power and is disposed decentered around the X-axis.

The shape of the reflecting surface 206a is preferably a rotationally asymmetric surface that has a plane of symmetry only on the Y-Z plane so as to allow favorable correction of the aberration caused by decentration, which is an aberration that is due to the decentered disposition of the reflecting surface 206a.

The reflecting mirror 206 is formed at a position where the distance along the axial principle ray 2050 from the intermediate image plane 205 to the reflecting surface 206a is the distance L_{z}.

By the reflecting mirrors 203, 204, and 206 explained above, a substantially afocal optical system is formed in which, after forming the intermediate image, a substantially parallel incident light beam 2051 is emitted as a substantially parallel light beam (below, for the sake of simplicity, this may be referred to as an afocal optical system). Specifically, the reflecting mirrors 203 and 204 form an object optical system, and the reflecting mirror 206 is an ocular optical system that can observe a virtual image that is an enlargement of the intermediate image when the position of the real image (intermediate image) formed by the objective optical system serves as the anterior focal position and a pupil is disposed at the position of the exit pupil 207.

In the present embodiment, in order that the afocal optical system has a compact size, where the maximum field angle in the Y direction on the object side is denoted θ_{oy}, the maximum field angle in the Y direction in the exit pupil 207, the image height of the intermediate image is denoted h, and the entrance pupil diameter is denoted D₀, the following equation is satisfied:
1.5<[{(θ_{ey}/θ_{oy})+2}×(h/tan θₑᵥ)]/D₀<10 (7)

In contrast, because the focal distance fₒ of the objective optical system and the focal distance fₑ of the ocular optical system are represented by the following equations:
fₒ=(θ_{ey}/θ_{oy})×(h/tan θ_{ey}) (8)
fₑ=h/tan θ_{ey} (9)
the equation (1) becomes:
1.5<(fₒ+2·fₑ)/Dₒ<10 (10)
and the appropriate range of the ratio of the approximate total optical path length of the afocal optical system from the first optical element to the exit pupil to the entrance pupil diameter Dₒ is determined.

When the term [{(θ_{ey}/θ_{oy})+2}×(h/tan θₑᵥ)] is smaller than the lower limiting value 1.5, the optical path length of the afocal optical system is small, and thus the reflecting mirrors 203 and 204 interfere with each other, and their respective amounts of decentration become too large. Thus, either they cannot be disposed, or even if they can be disposed, a large aberration due to decentration occurs.

In addition, when this term is larger than the upper limiting value 10, because the optical path length of the afocal optical system becomes long, the decentered optical system 201 becomes large scale even if the optical path is folded.

In order to accommodate the decentered optical system 201 in a well balanced and compact space, preferably the upper and lower limiting values fall within a range that is more narrow than equation (1). Concretely, preferably
2.0<[{(θ_{ey}/θ_{oy})+2}×(h/tan θₑᵥ)]/D₀<8.0 (7a)

More preferably,
4.0<[{(θ_{ey}/θ_{oy})+2}×(h/tan θₑᵥ)]/Dₒ<7.0 (7b)

The focusing device 2010 is provided decentered on the image side of the exit pupil 207, and is an optical element having a positive power for focusing the substantially parallel light beam reflected by the reflecting mirror 206 onto the light receiving surface 2011a. In the present embodiment, the focusing device 2010 consists, in sequence from the object side, of a lens 208 on which is formed a flat surface 208a and a convex surface 208b and which has a positive power, and consists, in sequence from the object side, a lens 209 on which are formed on the image side the spherical convex surface 209a and concave surface 209b and which has a positive power.

The light receiver 2011 is an element having a light receiving surface 2011a that receives the light focused by the focusing device. In addition, it is possible to dispose an optical fiber, photodiode (below, PD), a quarter PD (QD), an optical position sensitive detector (below, PSD), an charge coupled device (below, CCD), and the like as this element.

When using an optical fiber, because opto-electrical conversion along the path is not necessary, light transmission having ideal efficiency can be carried out. When using a PD, it is possible to widen the area by direct coupling to an optical fiber by carrying out opto-electrical conversion of the optical signal at the light receiving surface, and compared to an optical fiber, precision is not necessary. These two are used as light receiving elements for light that carries a signal.

When using a QD, because the light receiving surface is divided into four areas, and the light receiving position is detected by calculating the signal intensity of the four areas. In addition, if a signal is extracted based on variations in the intensity of the received light, it is possible to use this as is with a light receiving element for an optical signal. When using a PSD, it is possible to detect the focused position in two dimensions.

When using a CCD, it is possible to observe the received image and detect the position by image processing and calculating based on the focused position.

Note that in the present embodiment, preferably either the following conditions or an appropriate combination thereof are satisfied.

Where the intersection between an axial principal ray 2050 and the receiving surface 203a is denoted M₁ and the intersection between an axial principal ray 2050 reflected by the receiving surface 203a and the receiving surface 204a is denoted M₂, the position of the disposition of the reflecting mirror 204 is set such that the length L_{z} of the Z direction component of the line segment that connects point M₁ and point M₂, the effective diameter Dₒ of the receiving surface 203a, and the effective diameter D₁ of the receiving surface 204a satisfy the following equation.
0.35<{(D₁+D₂)/2}/L_{z}<2.0 (11)

When the term {(D₁+D₂)/2}/L_{z} is equal to or less than 0.35, the reflection angle of an axial principal ray becomes small, and thus if the position of the receiving surface 204a is not separated, it blocks the incident light beam 2051 incident on the reflecting mirror 203. When the receiving surface 204a is disposed at a position significantly separated from the receiving surface 203a order to prevent blocking, the optical system becomes large scale.

In addition, when this term is equal to or greater than 2.0, when the amount of decentration of the receiving surface 203a is not made large, it cannot be disposed. Thus, it is not possible to carry out advantageous aberration correction even when the receiving surfaces 203a and 204a are formed by rotationally asymmetric surfaces.

In order to accommodate the decentered optical system 201 is a more balanced and compact space, preferably the upper and lower limiting values fall within a range that is narrower than equation (11). Concretely, preferably
0.40<{(D₁+D₂)/2}/L_{z}<1.4 (11a)
and more preferably
0.50<{(D₁+D₂)/2}/L_{z}<0.85 (11b)

In addition, the position of the intermediate image plane 205 can disposed by varying the distance L₂₃ by suitably combining the surface shapes of the receiving surfaces 203a and 204a.

The distance L₂₃ preferably satisfies the following equation with respect to the entrance pupil Dₒ in order to give the diameter of the light beam incident on the receiving surface 204a a suitable size and so that the decentered optical system 201 does not make the intermediate image large.
0.1≦(L₂₃/Dₒ)≦10 (12)

When the ratio (L₂₃/Dₒ) is larger than the upper limiting value 10, the distance from the receiving surface 204a to the intermediate image plane 205 becomes too long, the effective diameter of the receiving surface 204a becomes too large, and thus the incident light beam 2051 incident on the reflecting mirror 203 and the receiving surface 204a block each other and obstruction occurs.

In addition, when the ratio (L₂₃/Dₒ) is smaller than the lower limiting value 0.1, the effective diameter of the receiving surface 204a becomes small and the shape necessary for carrying out advantageous aberration correction cannot be formed.

In order to make the diameter of the light beam incident on the reflecting mirror 204 a more suitable size and to make the size of the receiving surface 204a further improve the aberration correction capacity, preferably the ratio (L₂₃/Dₒ) falls within a range more narrow than equation (12). Concretely,
0.3≦(L₂₃/Dₒ)≦5 (12a)
and more preferably,
0.5≦(L₂₃/Dₒ)≦3 (12b)

In order to suppress divergence and convergence of the light beam incident on the exit pupil 207 and maintain the size of the diameter of the light beam substantially constant at the exit pupil 207, the substantially parallel light beam reflected by the reflecting mirror 206 preferably satisfies the following equation, where the angle between a principal ray of an axial light beam and the characteristic rays is denoted 0.
−3°≦θ≦4° (13)

When the angle θ is larger than the upper limiting value of ±4°, the divergence angle of the light beam becomes too large and the cost of providing a positive power in the focusing device 2010 after the light beam has passed through the exit pupil becomes large. Thus, the image forming capacity at the light receiving surface 2011a deteriorates.

In addition, when the angle θ is lower than the lower limiting value of −3°, the distance from the exit pupil 207 to the focusing device 2010 becomes short, and for example, when the light beam is reflected or refracted by disposing an optical element in the exit pupil 207, this optical element will interfere easily with the reflecting mirror 206, and thus disposition thereof becomes difficult.

In order to make an exit pupil 207 that has less fluctuation in the diameter, preferably the upper and lower limiting values of the angle θ fall within a more narrow range than the range of equation (13). Concretely,
−2°≦θ≦3° (13a)

More preferably,
−1°≦θ≦1.5° (13b)

In order to impart a suitable diameter to the substantially parallel light beam following reflection by the reflecting mirror 206, the distance L₂₂ from the intermediate image 205 where the reflecting mirror 206 is disposed preferably satisfies the following equation.
0.015≦(L₂₂/Do)≦0.7 (14)

When the ratio (L₂₂/Dₒ) is greater than the upper limiting value 0.7, the angular magnification cannot be made sufficiently large, and the diameter of the light beam incident on the exit pupil 207 becomes large.

In addition, when the ratio becomes smaller than 0.015, the intermediate image plane 205 and the reflecting mirror 206 become too close, and thus are formed adjacent to the exit pupil 207. Thereby, for example, when disposing an optical element or the like in order to carry out reflection or bending at the exit pupil 207, the optical element will easily interfere with the reflecting mirror 206.

In order to provide adequate space in proximity to the exit pupil 207 while imparting a more appropriate size to the diameter of the light beam incident on the exit pupil 207, preferably the proportion (L₂₂/Dₒ) falls in a range more narrow than that of equation (14). Concretely,
0.05≦(L₂₂/Dₒ)≦0.6 (14a)

More preferably,
0.1≦(L₂₂/Dₒ)≦0.5 (14b)

In addition, in order to provide a compact size while providing an advantageous image forming capacity for the intermediate image, preferably the size of the intermediate image falls within a suitable range. Thus, preferably the maximum incident angle θ_{my} in the Y direction from the object side and the focal distance F_{oy} of the object optical system in the Y direction within the afocal optical system satisfies the following equation.
0.5 (mm)<F_{oy}·tan θ_{my}<4.0 (mm) (15)

When the term F_{oy}·tan θ_{my} is equal to or less than 0.5 mm, F_{oy} becomes short and aberration correction becomes difficult. Thus, the image forming capacity for the intermediate image becomes low.

In addition, then the term is equal to or greater than 4.0 mm, F_{oy} becomes too large and the decentered optical system 201 becomes large scale.

In order to provide a compact size while providing a more advantageous image forming capacity for the intermediate image, preferably the upper and lower limiting values fall in a range that is more narrow than the range of equation (15). Concretely,
0.6 (mm)<F_{oy}·tan θ_{my}<3.0 (mm) (15a)

More preferably,

0.7 (mm)<F_{oy}·tan θ_{my}<2.0 (mm) (15b)

In order to make the aberration correction easy and to obtain an advantageous image forming capacity without making the scale of the optical system large, preferably the diameter of the exit pupil is equal to or greater than approximately 0.2 mm and equal to or less than approximately 40 mm. Specifically, the incident field angle θ₁ of the incident light beam 2051 on the entrance pupil, the incident field angle θ₂ a principal ray when the incident light beam 2051 is incident on the exit pupil, and the entrance pupil diameter Dₒ satisfy the following equation.
0.2 (mm)≦Dₒ·(θ₁/θ₂)≦40 (mm) (16)

When the exit pupil diameter is larger than the upper limiting value of 40 mm, the diameter of the incident light beam on the exit pupil 207 becomes large and the scale of the focusing device 2010 on the image side of the exit pupil 207 becomes large.

In addition, when the exit pupil diameter is smaller than the lower limiting value of 0.2 mm, for input light having a sufficient entrance pupil diameter equal to or greater than 10 mm, aberration correction becomes insufficient because the angular magnification becomes too large, and thereby advantageous image formation on the light receiving surface 2011a becomes difficult.

In order to provide a more suitable value to the diameter of the exit pupil and provide a decentered optical system having a superior image forming capacity, preferably the value of Dₒ·(θ₁/θ₂) ahs a range that is more narrow than equation (16). Concretely,
0.5 (mm)≦Dₒ·(θ₁/θ₂)≦30 (mm) (16a)

More preferably,
1 (mm)≦Dₒ·(θ₂/θ₂)≦20 (mm) (16b)

In addition, preferably the distance L₂₁ along an axial principal ray 2050 from the receiving surface 206a to the exit pupil 207 satisfies the following equation so that the position where the exit pupil 207 is formed is not too far from the receiving surface 206a.
0.01≦(L₂₁/Dₒ)≦0.7 (17)

When the ratio (L₂₁/Dₒ) is greater than the upper limiting value 0.7, the distance from the reflecting mirror 6 to the exit pupil 207 becomes long, and thus the decentered optical system 201 becomes large scale.

In addition, when the ratio (L₂₁/Dₒ) becomes less than the lower limiting value 0.01, the distance from the reflecting mirror 206 to the exit pupil 207 becomes too short, and for example, when a reflecting optical element or the like is disposed at the exit pupil 207, the reflecting optical element will interfere with the reflecting mirror 206, and thus disposition thereof becomes difficult.

In order to provide a more compact optical system and provide adequate space in proximity to the position of the exit pupil, preferably the ratio (L₂₁/Dₒ) falls in a range that is narrower than that of the equation (17). Concretely,
0.1≦(L₂₁/Dₒ)≦0.6 (17a)

More preferably,
0.2≦(L₂₁/Dₒ)≦0.5 (17b)

The operation of the decentered optical system 201 of the present embodiment will now be explained.

As shown in FIG. 9, the incident light beam 2051 travels towards the reflecting mirror 203 after the diameter of the light beam is limited restricted to the entrance pupil diameter Dₒ due to being incident on the aperture stop 202. Then, when the incident light beam 2051 reaches the receiving surface 203a, the optical path is folded depending on the direction of decentration (the positive direction around the X-axis) of the receiving surface 203a while being focused by the positive power of the receiving surface 203a, and is guided to the reflecting mirror 204 disposed at a position that does not block the incident light beam 2051 or the aperture stop 202 before reaching the reflecting mirror 203. At this time, if the receiving surface 203a has a rotationally asymmetric surface shape, and in particular, a rotationally asymmetric free-formed surface having a plane of symmetry only in the Y-Z plane, it is possible to carry out aberration correction advantageously.

At the reflecting mirror 204, the receiving surface 204a is decentered in the positive direction around the X-axis and is a rotationally asymmetric decentered receiving surface having a positive power. Thus, it is possible to fold the optical path at a position that does not block the incident light beam 2051 or the reflecting mirror 203 before reaching the reflecting mirror 203.

When the effective diameters D₁ and D₂ of the reflecting mirrors 203 and 204 satisfy the equation (11), the positional relationship between the reflecting mirrors 203 and 204 in the Y direction and the Z direction is restricted, and the incident light beam 2051 is reflected at the reflecting mirror 204 at a suitable angle. Specifically, because the distance L_{z} has a suitable length, the amount of decentration of the receiving surface 203a will not become large while the size in the Z direction is made compact. Thus, there are the advantages that it is possible to reduce the aberration caused by decentration due to the receiving surface 203a, and advantageous aberration correction becomes possible.

Because the receiving surface 204a is formed by a rotationally asymmetric free-formed surface, by imparting a shape for the receiving surface 204a that provides a curvature and tilt that cancels the aberration caused by decentration, the normal aberration and the aberration caused by decentration of the light beam reflected by the reflecting mirror 203 that has a positive power can be advantageously corrected.

In addition, the light beam whose aberration has been corrected after being reflected by the reflecting mirror 204 is further converged, and an intermediate image is formed on the intermediate image plane 205, which is at a position having a distance L₂₃ from the reflecting mirror 204.

If the distance L₂₃ satisfies the equation (12), because a suitable diameter can be imparted to the light beam incident on the receiving surface 204a, there is the advantage that a sufficient aberration correction capacity can be provided to the receiving surface 204a. In addition, because the diameter of the light beam incident on the receiving surface 204a does not become too large, there are the advantages that difficulty in the disposition of the reflecting mirror 204 due to a large size does not occur and obstruction of the incident light beam 2051 incident on the reflecting mirror 203 does not occur.

In addition, the reflecting mirror 204 reflects such that reflecting mirror 203 does not block the light beam of the intermediate image and an axial principal ray traveling towards the intermediate image and the Z-axis are substantially parallel. Thereby, it is possible to make the optical system small scale in the Y-axis direction. Here, the angle between the Z-axis and the principal ray from the reflecting mirror 204 to the intermediate image is equal to or less than 10°. In addition, preferably the angle is equal to or less than ±5°. In addition, in this configuration the position of the intermediate image centered on the optical axis is equal to or less than Do/2 from the edge of the effective diameter of the reflecting mirror 203. Thereby, a small-scale optical system similarly becomes possible.

In addition, when F_{oy}·tan θ_{my}, which is the height of the intermediate image in the Y direction, satisfies equation (15), there are the advantages that the focal distance F_{oy} of the object optical system in the Y direction has imparted an appropriate size, the image forming capacity of the intermediate image becomes favorable, and it is possible to accommodate the size of the decentered optical system 201 within a rational range.

The light beam that forms the intermediate image gradually diverges, reaches the reflecting mirror 206 disposed at a position downstream by a distance L₂₂, and is reflected by the reflecting surface 206a. The light beam is made a substantially parallel light beam by the positive power of the reflecting surface 6a, and an exit pupil 207 is formed at a position downstream by distance L₂₁.

The reflecting surface 206a is decentered in the positive direction around the X-axis, and thus the light beam can be folded at a position at which the reflected light avoids entering into the intermediate image plane 205 and is not blocked by the reflecting mirror 204. Therefore, the optical path can be folded into a substantially W shape without light loss occurring due to obstruction or the like caused by the reflecting mirrors 203, 204, and 206, and thereby it is possible to form a compact and real afocal optical system.

In addition, the exit pupil 207 is formed at a position downstream by distance L₂₁ on the image side. Thereby, in the case that functionality is being added to the decentered optical system 201 by adding an optical element, it is possible to make the effective diameter of the optical element small by positioning the optical element in proximity to the exit pupil 207. Specifically, it is possible to manufacture inexpensively the optical element to be disposed and dispose it easily. Therefore, there is the advantage that an optical device that adds high performance to the decentered optical system 201 can be manufactured inexpensively and having a small scale.

A galvano-mirror that deflects the substantially parallel light beam reflected by the reflecting mirror 206 is an example of such an optical element. The galvano-mirror can be made small because only a small effective diameter for the reflecting surface is necessary, and thus a faster deflection becomes possible.

In addition, a filter element and a half-mirror are examples of different optical elements. There are the advantages that the precision of the parts can be increased and inexpensive manufacture becomes possible even when an expensive coating is applied.

The light beam emitted from the exit pupil 207 is incident on the focusing device 2010 while diverging at angle θ₁. Then the light beam is focused by the positive power of the focusing device 2010 and an image is formed on the image receiving surface 2011a.

Depending on the type of the light receiver 2011 that has been disposed, the image receiving surface 2011a detects the observed image, the amount of light, and the position of the received light, and for example, in the case of an optical fiber, guides the incident light into the light transmitting path.

In the present embodiment, when the distance L₂₂ satisfies the equation (14), there is the advantage that the distance has a suitable size imparted, and there is no blocking even in the case that an optical element is disposed in proximity to the exit pupil 207 because the distance L₂₂ becomes too short. In addition, the angular magnification of the afocal optical system has imparted an appropriate size, and the diameter of the substantially parallel light beam incident on the exit pupil 207 has imparted an appropriate size.

In addition, when the substantially parallel light beam reflected by the reflecting mirror 206 satisfies equation (13), it a substantially parallel light beam having suppressed divergence and convergence becomes possible, and thus the size of the diameter of the light beam in the exit pupil 207 can be maintained substantially constant. Fluctuations in the diameter of the exit pupil due to manufacturing error or installation error of the other optical elements can be suppressed, and, for example, when the light beam is reflected or bent by disposing an optical element in proximity to the exit pupil 207, it is possible to prevent light loss due to obstruction, and it is possible to make the effective diameter of the optical element small.

When the exit pupil satisfies equation (16), the exit pupil can be made approximately equal to or greater than 0.2 mm and approximately equal to or less than 40 mm. With such an exit pupil, it is possible to prevent the scale of the optical system on the image side of the exit pupil 207 from becoming large. In addition, there are the advantages that the angular magnification of the substantially afocal optical system becomes suitable, and it is possible to carry out advantageous aberration correction.

In addition, when the distance L₂₁ satisfies equation (17), another optical element can be easily disposed at the exit 207, for example, because the exit pupil 207 is formed at a positioned separated only by an appropriate distance from the reflecting mirror 206. Therefore, there are the advantages that light loss does not occur and construction of a higher performance optical system becomes possible.

In addition, in the present embodiment, because a substantially parallel light beam emitted from the exit pupil 207 is focused by the focusing device 2010 and guided to the light receiving surface 2011a, the focusing device 2010 can be freely disposed in the direction of the optical axis. As a result, there is the effect that the layout of the optical device using the decentered optical system 201 becomes easy.

For example, it is possible to fold the optical path by using a planar mirror and dispose the light receiver 2011 at a convenient position.

In addition, for example, by providing a device (first optical path splitting device) such as a beam splitter that splits the optical path along the optical path of the substantially parallel light beam, it is possible to split the optical path, dispose a separate focusing device 2010 and light receiver 2011 along the optical path after splitting, and receive light at a plurality of light receivers 2011. At this time, by changing the optical path length up to the respective light receiving surfaces 2011a, it is possible to change the amount of movement of the light beam on a light receiving surface 2011a with respect to the incident field angle easily. Here, the plurality of light receivers 2011 does not need to be identical optical elements or light receiving members, and ones having different functions and sensitivities can be used. Thereby, there is the advantage that multiple purpose light reception becomes possible.

Note that in the above explanation, the operation from the image side to the image plane of the decentered optical system 201 was explained for the case of a light receiving optical system that receives an incident light beam 2051 at a light receiving surface 2011a. However, of course, if these optical paths are reversed, the light receiving optical system then becomes a light transmitting optical system that emits a light beam from the aperture stop 202. Specifically, by disposing a divergent light source at a position corresponding to the light receiving surface 2011a and making the substantially parallel light beam incident from the image side of the exit pupil 207, the optical path is reversed, reflected by the reflecting mirror 203, and thereby the substantially parallel light beam is emitted from the aperture stop 202 on the object side.

In this case, the device for splitting the optical path explained above can be used as an optical path merging device during the optical path reverse.

Note that equations (7), (11) to (17) and equations (7a), (7b), (11a), (11b) to (17a), and (17b) can be appropriately used in a plurality of combinations.

Next, a plurality of modifications of the decentered optical system 201 according to the third embodiment will be explained focusing on the differences with the embodiment described above. In the following, a structure is formed in which equation (7) is satisfied in all cases, and the equations (11) to (17), and equations (7a), (7b), (11a), (11b) to (17a), and (17b) are conditions that are preferably applied to the following modifications. The definitions of the quantities in the equations can be easily understood by their correspondence to each of the members, and thus in the figures they are denoted by the same reference numerals and their explanations are omitted.

First Modification

The first modification of the decentered optical system 201 will now be explained.

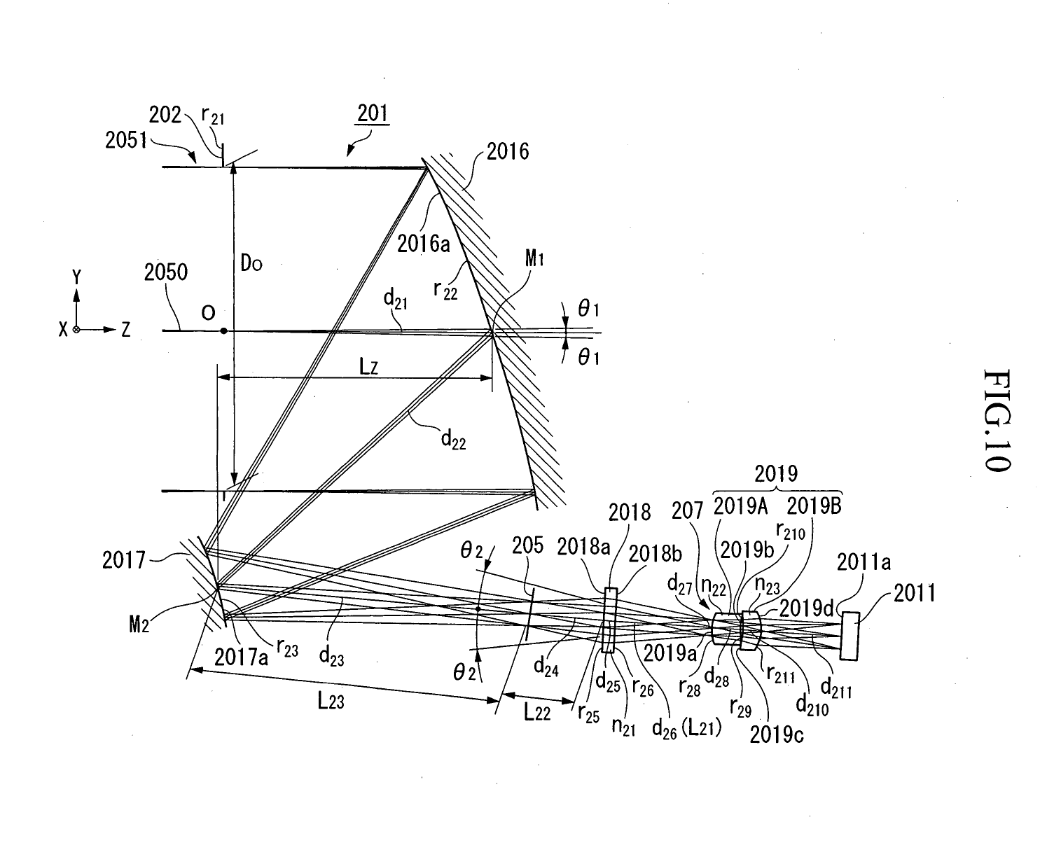

FIG. 10 is a cross-sectional optical path diagram that includes the optical path of an axial principal ray in order to explain the first modification of the present embodiment.

Instead of the reflecting mirrors 203, 204, and 206 and the focusing device 2010 of the embodiment described above, this modification provides a reflecting mirror 2012 (first optical element), a reflecting mirror 2013 (second optical element) a focusing lens 2014 (third optical element), and a focusing lens 2015 (focusing device). Here, the coefficients of the free-formed surface equation and the amount of decentration of the reflecting surfaces 2012a and 2013a (decentered reflecting surfaces) of the reflecting mirrors 2012 and 2013 differ only slightly from those of the respective corresponding receiving surface 203a and receiving surface 204a, and their explanation has been omitted. However, it is a condition of the above that the tilt of the intermediate image plane 205 becomes comparatively small.

This modification is an example characterized by the point that the third optical element formed by a reflecting optical element in the above embodiment is formed by a refracting lens.

The focusing lens 2014 is a lens element consisting of a two-layer structure comprising the lenses 2014A and 2014B. The lens 2014A is a meniscus lens providing a concave surface 2014a and a convex surface 2014b and having a positive power. The lens 2014B is a biconvex lens that provides a convex surface 2014c and a convex surface 2014d. Therefore, this focusing lens 2014 has a positive power as a whole. By using a two-layer structure, each of the optically active surfaces forms a spherical axially symmetrical lens.

The focusing lens 2015 is a lens element consisting of a two-layer structure comprising a lens 2015A and a lens 2015B. The lens 2015A is a meniscus lens providing a convex surface 2015a and a concave surface 2015b and having a positive power. The lens 2015B is a biconvex lens that provides a convex surface 2015c and a convex surface 2015d. Therefore, this focusing lens 2015 has a positive power as a whole. By using a two-layer structure, each of the optically active surfaces forms a spherical axially symmetrical lens.

In addition, because the image forming capacity for the intermediate image in the afocal optical system is advantageous and the tilt of the intermediate image plane 2050 is comparatively small, a focusing lens 2014, which is an ocular optical system, is formed by using a refracting lens and this lens can be disposed coaxially with respect to an axial principal ray 2050 reflected by the reflecting surface 2013a.

According to this modification, it is possible to form an exit pupil 207 downstream of the focusing lens 2014. Therefore, the reflecting mirror 2012, the reflecting mirror 2013, and the exit pupil 207 on the downstream side of the focusing lens 2014 are formed, for example, there is the advantage that by appropriately folding and splitting the substantially parallel light beam emitted through the exit pupil 207, it is possible to form a optical path having a comparatively high freedom of design.

In addition, because the focusing lenses 2014 and 2015 are formed by spherical lenses, there is the advantage that they can be manufactured inexpensively.

Second Modification

The second modification of the decentered optical system 201 will now be explained.

FIG. 11 is a cross-sectional optical path diagram that includes the optical path on an axial principal ray in order to explain the second modification of the present embodiment.

In this modification, instead of the reflecting mirrors 203, 204, and 206 and the focusing device 2010 of the embodiment described above, a reflecting mirror 2016 (first optical element), reflecting mirror 2017 (second optical element), a Fresnel lens 2018 (third optical element), and a focusing lens 2019 (focusing device) are provided.

Here, the coefficients of the free-formed surface equation and the amount of decentration of the reflecting surfaces 2016a and 2016a (decentered reflecting surfaces) of the reflecting mirrors 2016 and 2017 differ only slightly from those of the respective corresponding receiving surface 203a and receiving surface 204a, and their explanation has been omitted. However, it is a condition of the above that the tilt of the intermediate image plane 205 becomes comparatively small.

The present modification is an example that is characterized in the point that the third optical element formed by the reflecting optical element in the embodiment described above is formed by a Fresnel lens.

The Fresnel lens 2018 is a Fresnel lens element providing from the object side the Fresnel lens surfaces 2018a and 2018b and has a positive power.

The focusing lens 2019 is a lens element consisting of a two-layer structure comprising the lenses 2019A and 2019B. The lens 2019A is a meniscus lens providing a convex surface 2019a and a concave surface 2019b and having a positive power. In addition, the convex surface 2019a is disposed at a position substantially overlapping the exit pupil 207.

The lens 2019A is a meniscus lens providing the concave surface 2019c and the convex surface 2019b and has a positive power. Therefore, the lens 2019B has a positive power as a whole. Due to having the two-layer structure, each of the optically active surfaces forms a spherical axially symmetrical lens.

In addition, like the first modification, the image forming capacity for the intermediate image in the afocal optical system is advantageous and the tilt of the intermediate image plane 205 is made comparatively small. Thus a Fresnel lens, which is a ocular optical system, is formed by a refracting lens, and it is possible to dispose the Fresnel lens 2018 coaxially with respect to an axial principal ray 2050 reflected by the reflecting surface 2013a.

According to the present modification, by using a Fresnel lens for the ocular optical system, in addition to the operation and effect of the first modification using a spherical lens, there are the advantages that it is possible to make the lens thin and it is possible to make decentered optical system 201 compact and lightweight.

In addition, because the convex surface 2019a is disposed substantially overlapping the exit pupil 207 and because the effective diameter of the lens 2019A on the object side can be made comparatively small, it is possible to make the scale of the optical system small.

Third Modification

The third modification of the decentered optical system 201 will now be explained.

FIG. 12 is a cross-sectional optical path diagram that includes the optical path of an axial principal ray in order to explain the third modification of the present embodiment.

Instead of the reflecting mirrors 203, 204, and 206 and the focusing device 2010 and the light receiver 2011, the present modification provides a reflecting mirror 2020 (first optical element), a reflecting mirror 2021 (second optical element), a reflecting mirror 2022 (third optical element), a focusing lens 2025 (focusing device), and a light receiver 2011B (light receiving device), and in addition adds a beam splitter 2064A (second beam splitting device), a reflecting mirror 2023 (light deflecting device), a beam splitter 2064B (first optical path splitting device), and light receivers 2011A and 2011C (light receiving device). Here, the coefficients of the free-formed surface equation and the amount of decentration of the reflecting surface 2020a and reflecting surface 2021a (decentered reflecting surfaces) and the receiving surface 2034a of the reflecting mirrors 2020, 2021 and 2022 differ only slightly from those of the respective corresponding receiving surfaces 203a, 204a, and 206a, and their explanation has been omitted. In addition, the light receivers 2011A, 2011B, and 2011C can use light receiving elements and light receiving materials that are identical to that of the light receiver 2011.

Like the second modification, the beam splitter 2064A is disposed between the reflecting mirror 2021 and the intermediate image plane 205 along the optical path, the optical path is split, and at a position that does not overlap the optical path passing through the beam splitter 2064A, the other optical paths, or other optical elements, the intermediate image plane 205 is returned and a separate intermediate image (another intermediate image) is formed. In addition, the light receiver 2011 is disposed such that the light receiving surface 2011a is positioned on the image plane thereof.

A beam splitter prism that has had a half-mirror coating applied, a half-mirror, a polarization beam splitter (PBS) that splits the optical path depending on polarization properties, an optical element that splits the optical path depending on wavelength characteristics or the like can be used as the beam splitter 2064A.

The reflecting mirror 2023 is an optical element that provides a planar reflecting surface 2023a that can move on two axes, and for example, a galvano-mirror that is driven by an appropriate rotation drive device such as an actuator, optical MEMS (micro electro mechanical systems) or the like can be used. In addition, the receiving surface 2023a is disposed at a position substantially overlapping the exit pupil 207 formed on the image side of the reflecting mirror 2022.

The beam splitter 2064B is for splitting the substantially parallel light beam after being emitted through the exit pupil 207 into a transmitted beam and a split beam, and a structure identical to that of the beam splitter 2064A can be used.

The focusing lens 2025 is for focusing the respective substantially parallel light beams split by the beam splitter 2064A onto a light receiving surface 2011a, and is a doublet that couples the convex lens 2025A and the concave lens 2025B. In addition, it is an axially symmetrical lens that provides from the object side the spherical convex surface 2025a, the doublet surface 2025b, the convex surface 2025a, and has a positive power as a whole. The distance of a focusing lens 2025 to the beam splitter 2064B is set at a distance that is different on the optical path of the transmitted beam and the split beam.

In addition, the light receiving surface 2011a of the light receiver 2011B is disposed on the image forming plane of the split beam, and the light receiving surface 2011a of the light receiver 2011C is disposed at the image forming plane of the transmitted beam.

According to this modification, the light beam is split between the reflecting mirror 2021 and the intermediate image plane 205 by the beam splitter 2064A, and thereby it is possible to extract an intermediate image having a superior image forming capacity for reception by the light receiving surface 2011a. For example, if a CCD is used as the light receiver 2011A, it is possible to observe an intermediate image and detected the position of an intermediate image. In addition, if a position detecting sensor is disposed, it is possible to detect the direction of the incident field angle.

In addition, because a substantially parallel light beam is split after being emitted through the exit pupil 207 and light receivers 2011B and 2011C are disposed on the image side, it is possible for the substantially parallel light beam to form images on two light receiving surfaces 2011a. Therefore, for example, if position detecting sensors having respectively different detection sensitivities are provided at the light receivers 2011B and 2011C, it becomes possible to detect the direction of incidence of the incident light beam 2051 by using different detection sensitivities.

In the case that position detecting sensors or the like are placed at a light receiving surface 2011a to detect the direction of incidence of the incident light beam 2051, based on the detection data, it is possible to make a suitable optical system for carrying out light tracking of the incident light beam 2051 by moving the decentered optical system 201.

In addition, because a substantially parallel light beam reflected by the reflecting mirror 2022 can be deflected in the direction of two axes by moving the reflecting mirror 2023, for example, it is possible to variably control the position of incidence of the light beam with respect to the focusing lenses 2025 and 2025 by controlling the deflection angle depending on the fluctuation in the direction of incidence of the incident light beam 2051. In particular, by eliminating the fluctuation in the direction of incidence of the incident light beam 2051, it becomes possible to form images at a constant position.

Note that examples were explained wherein a focusing lens 2025 between the beam splitter 2064B and the light receiving surfaces 2011a and 2011a, but focusing devices having different focal distances can also be so disposed. In addition, the focusing device is not limited to a lens element, but a reflecting optical element can also be used.

### EXAMPLE 1

Next, a first numerical example of the decentered optical system of the third embodiment explained above will be explained with reference to FIG. 9.

Below, the structural parameters of the optical system of the third numerical example are shown. The terms rᵢ and nᵢ (i being an integer) shown in FIG. 9 correspond to rᵢ and nᵢ of the structural parameters of the optical system described below. In addition, the index of refraction is shown with respect to the line d (wavelength 587.56 nm).

The coordinate system and the like have been explained above, and thus their explanation has been omitted. Angles α, β, and γ that denote the decentration show the angle of the direction that has been explained above as the direction of the tilt angle. The unit of length is mm and the unit for angles is degrees (°). In addition, the origin of the decentration and the center of rotation are appropriately noted in the data. In addition, a free-formed surface (FFS surface) and an aspheric surface are described by the equation (a) above. Note that the term related to the free-formed surface and the aspheric surface not shown in the data are 0.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 40.00 | | | |
| 2 | FFS[1] | d₂ = 0.00 | decentration [1] | | |
| 3 | FFS[2] | d₃ = 0.00 | decentration [2] | | |
| 4 | intermediate | d₄ = 0.00 | decentration [3] | | |
| | image plane | | | | |
| 5 | FFS[3] | d₅ = 0.00 | decentration [4] | | |
| 6 | exit pupil | d₆ = 0.00 | decentration [5] | | |
| 7 | r₆ = 220.12 | d₇ = −2.00 | decentration [6] | n₁ = 1.5163 | ν₁ = 64.1 |
| 8 | r₈ = 12.06 | d₈ = −0.50 | | | |
| 9 | r₉ = −6.61 | d₉ = −2.85 | decentration [7] | n₂ = 1.5163 | ν₂ = 64.1 |
| 10 | r₁₀ = −7.89 | d₁₀ = −10.11 | | | |
| image | ∞ | d₁₁ = 0.00 | | | |
| plane | | | | | |

FFS[1]

| | | | | | |
|---|---|---|---|---|---|
| C₄ | −3.7636 × 10⁻³ | C₆ | −3.3556 × 10⁻³ | C₈ | 9.8797 × 10⁻⁶ |
| C₁₀ | 9.0539 × 10⁻⁶ | C₁₁ | −2.2981 × 10⁻⁸ | C₁₃ | −6.9738 × 10⁻⁸ |
| C₁₅ | −4.1198 × 10⁻⁸ | | | | |

FFS[2]

| | | | | | |
|---|---|---|---|---|---|
| C₄ | −1.1221 × 10⁻² | C₆ | −1.0514 × 10⁻² | C₈ | 2.4337 × 10⁻⁴ |
| C₁₀ | 2.4512 × 10⁻⁴ | C₁₁ | −5.3777 × 10⁻⁶ | C₁₃ | −1.8044 × 10⁻⁵ |
| C₁₅ | −1.0764 × 10⁻⁵ | | | | |

FFS[3]

| | | | | | |
|---|---|---|---|---|---|
| C₄ | −1.5260 × 10⁻² | C₆ | −1.4591 × 10⁻² | C₈ | 2.1083 × 10⁻⁴ |
| C₁₀ | 2.6585 × 10⁻⁴ | C₁₁ | 9.5988 × 10⁻⁶ | C₁₃ | 2.3468 × 10⁻⁵ |
| C₁₅ | 1.3339 × 10⁻⁵ | | | | |

decentration [1]

| | | | | | |
|---|---|---|---|---|---|
| X | 0.00 | Y | 0.00 | Z | 0.00 |
| α | 20.39 | β | 0.00 | γ | 0.00 |

decentration [2]

| | | | | | |
|---|---|---|---|---|---|
| X | 0.00 | Y | −35.76 | Z | −42.82 |
| α | 20.31 | β | 0.00 | γ | 0.00 |

decentration [3]

| | | | | | |
|---|---|---|---|---|---|
| X | 0.00 | Y | −38.46 | Z | −1.50 |
| α | −3.23 | β | 0.00 | γ | 0.00 |

decentration [4]

| | | | | | |
|---|---|---|---|---|---|
| X | 0.00 | Y | −35.24 | Z | 14.20 |
| α | 15.00 | β | 0.00 | γ | 0.00 |

decentration [5]

| | | | | | |
|---|---|---|---|---|---|
| X | 0.00 | Y | −45.03 | Z | −2.92 |
| α | 18.00 | β | 0.00 | γ | 0.00 |

decentration [6]

| | | | | | |
|---|---|---|---|---|---|
| X | 0.00 | Y | −49.36 | Z | −16.23 |
| α | 18.00 | β | 0.00 | γ | 0.00 |

decentration [7]

| | | | | | |
|---|---|---|---|---|---|
| X | 0.00 | Y | 0.00 | Z | 0.00 |
| α | 0.00 | β | 0.00 | γ | 0.00 |

### EXAMPLE 2

Next, a second numerical example that corresponds to the first modification of the decentered optical system of the third embodiment explained above will be explained with reference to FIG. 10.

The structural parameters of the optical system of the second numerical example are shown below. The terms rᵢ and nᵢ (where i is an integer) shown in FIG. 11 correspond to rᵢ and nᵢ of the structural parameters of the optical system shown below. The refraction index corresponds to line d (wavelength 587.56 nm).

The coordinate system and other aspects are identical to those of the first example.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 40.00 | | | |
| 2 | FFS[1] | d₂ = 0.00 | decentration [1] | | |
| 3 | FFS[2] | d₃ = 0.00 | decentration [2] | | |
| 4 | intermediate | d₄ = 0.00 | decentration [3] | | |
| | image] | | | | |
| 5 | r₅ = −79.14 | d₅ = 2.65 | decentration [4] | n₁ = 1.5163 | ν₁ = 64.1 |
| 6 | r₆ = −13.01 | d₆ = 0.98 | | | |
| 7 | r₇ = 32.28 | d₇ = 2.59 | | n₂ = 1.5163 | ν₂ = 64.1 |
| 8 | r₈ = −29.74 | d₈ = 16.55 | | | |
| 9 | exit pupil | d₉ = 14.99 | | | |
| 10 | r₁₀ = 12.37 | d₁₀ = 1.60 | | n₃ = 1.5163 | ν₃ = 64.1 |
| 11 | r₁₁ = 9.28 | d₁₁ = 0.50 | | | |
| 12 | r₁₂ = 24.00 | d₁₂ = 2.30 | | n₄ = 1.5163 | ν₄ = 64.1 |
| 13 | r₁₃ = −10.21 | d₁₃ = 18.13 | | | |
| image | ∞ | d₁₄ = 0.00 | | | |
| plane | | | | | |

FFS[1]

| | | | | | |
|---|---|---|---|---|---|
| C₄ | −3.4909 × 10⁻³ | C₆ | −3.2017 × 10⁻³ | C₈ | 8.6691 × 10⁻⁶ |
| C₁₀ | 8.2685 × 10⁻⁶ | C₁₁ | −6.8017 × 10⁻⁹ | C₁₃ | −3.8686 × 10⁻⁸ |
| C₁₅ | −2.7179 × 10⁻⁸ | | | | |

FFS[2]

| | | | | | |
|---|---|---|---|---|---|
| C₄ | −8.3450 × 10⁻³ | C₆ | −8.4875 × 10⁻³ | C₈ | 1.6940 × 10⁻⁴ |
| C₁₀ | 1.8357 × 10⁻⁴ | C₁₁ | 1.1224 × 10⁻⁶ | C₁₃ | −2.3713 × 10⁻⁶ |
| C₁₅ | −3.0542 × 10⁻⁶ | | | | |

decentration [1]

| | | | | | |
|---|---|---|---|---|---|
| X | 0.00 | Y | 0.00 | Z | 0.00 |
| α | 21.43 | β | 0.00 | γ | 0.00 |

decentration [2]

| | | | | | |
|---|---|---|---|---|---|
| X | 0.00 | Y | −35.47 | Z | −44.05 |
| α | 23.57 | β | 0.00 | γ | 0.00 |

decentration [3]

| | | | | | |
|---|---|---|---|---|---|
| X | 0.00 | Y | −44.00 | Z | 6.76 |
| α | −17.00 | β | 0.00 | γ | 0.00 |

decentration [4]

| | | | | | |
|---|---|---|---|---|---|
| X | 0.00 | Y | −44.59 | Z | 20.07 |
| α | −4.29 | β | 0.00 | γ | 0.00 |

### EXAMPLE 3

Next, a third numerical example that corresponds to the second modification of the decentered optical system of the third embodiment explained above will be explained with reference to FIG. 11.

Below, the structural parameters of the optical system of the third numerical example are shown. The terms rᵢ and nᵢ (where i is an integer) shown in FIG. 11 correspond to rᵢ and nᵢ of the structural parameters of the optical system described below. In addition, the index of refraction is shown with respect to the line d (wavelength 587.56 nm).

The coordinate system and other aspects are identical to those of example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 40.00 | | | |
| 2 | FFS[1] | d₂ = 0.00 | decentration [1] | | |
| 3 | FFS[2] | d₃ = 0.00 | decentration [2] | | |
| 4 | intermediate | d₄ = 0.00 | decentration [3] | | |
| | image | | | | |
| 5 | aspheric [1] | d₅ = 2.00 | decentration [4] | n₁ = 1.5254 | ν₁ = 56.2 |
| | surface | | | | |
| 6 | aspheric [2] | d₆ = 13.95 | | | |
| | surface | | | | |
| 7 | exit pupil | d₇ = 0.25 | | | |
| 8 | r₈ = 8.05 | d₈ = 3.96 | | n₂ = 1.5163 | ν₂ = 64.1 |
| 9 | r₉ = 4.33 | d₉ = 0.40 | | | |
| 10 | r₁₀ = −34.37 | d₁₀ = 2.87 | | n₃ = 1.5163 | ν₃ = 64.1 |
| 11 | r₁₁ = −3.70 | d₁₁ = 11.61 | | | |
| image | ∞ | d₁₂ = 0.00 | | | |
| plane | | | | | |

aspheric surface [1]

radius of curvature 12.73

| | |
|---|---|
| k | 0.0 |

aspheric surface [2]

radius of curvature −12.95

| | |
|---|---|
| k | 0.0 |

FFS[1]

| | | | | | |
|---|---|---|---|---|---|
| C₄ | −3.7343 × 10⁻³ | C₆ | −3.5137 × 10⁻³ | C₈ | 9.8395 × 10⁻⁶ |
| C₁₀ | 9.6522 × 10⁻⁶ | C₁₁ | 1.0137 × 10⁻⁸ | C₁₃ | −1.8198 × 10⁻⁸ |
| C₁₅ | −2.9547 × 10⁻⁸ | | | | |

FFS[2]

| | | | | | |
|---|---|---|---|---|---|
| C₄ | −9.2177 × 10⁻³ | C₆ | −1.2408 × 10⁻² | C₈ | 2.2194 × 10⁻⁴ |
| C₁₀ | 2.8633 × 10⁻⁴ | C₁₁ | 3.1805 × 10⁻⁶ | C₁₃ | 5.3581 × 10⁻⁶ |
| C₁₅ | −2.2227 × 10⁻⁶ | | | | |

decentration [1]

| | | | | | |
|---|---|---|---|---|---|
| X | 0.00 | Y | 0.00 | Z | 0.00 |
| α | 20.67 | β | 0.00 | γ | 0.00 |

decentration [2]

| | | | | | |
|---|---|---|---|---|---|
| X | 0.00 | Y | −34.81 | Z | −40.78 |
| α | 19.65 | β | 0.00 | γ | 0.00 |

decentration [3]

| | | | | | |
|---|---|---|---|---|---|
| X | 0.00 | Y | −39.31 | Z | 5.40 |
| α | −8.00 | β | 0.00 | γ | 0.00 |

decentration [4]

| | | | | | |
|---|---|---|---|---|---|
| X | 0.00 | Y | −40.05 | Z | 15.97 |
| α | −4.06 | β | 0.00 | γ | 0.00 |

Fourth Example

Next, a fourth numerical example that corresponds to the third modification of the decentered optical system of the third embodiment explained above will be explained with reference to FIG. 12. However, the beam splitter 2064A and the optical path after the beam splitting have been omitted. In addition, the optical path transmitted through the beam splitter 2064B is also omitted.

Below, the structural parameters of the optical system of the third numerical example are shown. The terms rᵢ and nᵢ (i being an integer) shown in FIG. 12 correspond to rᵢ and nᵢ of the structural parameters of the optical system described below. In addition, the index of refraction is shown with respect to the line d (wavelength 587.56 nm).

The coordinate system and other aspects are identical to those of example 1.

| Surface | radius of | plane | | index of | Abbe |
|---|---|---|---|---|---|
| number | curvature | interval | decentration | refraction | number |
| object | ∞ | ∞ | | | |
| plane | | | | | |
| 1 | stop plane | d₁ = 40.00 | | | |
| 2 | FFS[1] | d₂ = 0.00 | decentration [1] | | |
| 3 | FFS[2] | d₃ = 0.00 | decentration [2] | | |
| 4 | intermediate | d₄ = 0.00 | decentration [3] | | |
| | image | | | | |
| 5 | FFS[3] | d₅ = 0.00 | decentration [4] | | |
| 6 | r₆ = ∞ | d₆ = 0.00 | decentration [5] | | |
| 7 | r₇ = ∞ | d₇ = 0.00 | decentration [6] | | |
| 8 | r₈ = ∞ | d₈ = 0.00 | decentration [7] | | |
| 9 | r₉ = ∞ | d₉ = 0.00 | decentration [8] | | |
| 10 | r₁₀ = 13.98 | d₁₀ = 5.25 | decentration [9] | n₁ = 1.6667 | ν₁ = 48.3 |
| 11 | r₁₁ = −9.35 | d₁₁ = 1.10 | | n₂ = 1.7282 | ν₂ = 28.4 |
| 12 | r₁₂ = −76.14 | d₁₂ = 7.00 | | | |
| image | ∞ | d₁₃ = 0.00 | | | |
| plane | | | | | |

FFS[1]

| | | | | | |
|---|---|---|---|---|---|
| C₄ | −4.3152 × 10⁻³ | C₆ | −3.7465 × 10⁻³ | C₈ | 1.2185 × 10⁻⁵ |
| C₁₀ | 1.1586 × 10⁻⁵ | C₁₁ | −7.9302 × 10⁻⁹ | C₁₃ | −5.2313 × 10⁻⁸ |
| C₁₅ | −4.4610 × 10⁻⁸ | | | | |

FFS[2]

| | | | | | |
|---|---|---|---|---|---|
| C₄ | −1.8482 × 10⁻² | C₆ | −1.3278 × 10⁻² | C₈ | 4.2739 × 10⁻⁴ |
| C₁₀ | 4.2539 × 10⁻⁴ | C₁₁ | 1.2184 × 10⁻⁵ | C₁₃ | 5.5130 × 10⁻⁶ |
| C₁₅ | −1.1712 × 10⁻⁵ | | | | |

FFS[3]

| | | | | | |
|---|---|---|---|---|---|
| C₄ | −2.2047 × 10⁻² | C₆ | −1.9196 × 10⁻² | C₈ | −2.0762 × 10⁻⁴ |
| C₁₀ | 3.2857 × 10⁻⁵ | C₁₁ | −8.2735 × 10⁻⁶ | C₁₃ | −1.7109 × 10⁻⁵ |
| C₁₅ | −5.4736 × 10⁻⁶ | | | | |

decentration [1]

| | | | | | |
|---|---|---|---|---|---|
| X | 0.00 | Y | 0.00 | Z | 0.00 |
| α | 20.38 | β | 0.00 | γ | 0.00 |

decentration [2]

| | | | | | |
|---|---|---|---|---|---|
| X | 0.00 | Y | −32.53 | Z | −39.18 |
| α | 22.88 | β | 0.00 | γ | 0.00 |

decentration [3]

| | | | | | |
|---|---|---|---|---|---|
| X | 0.00 | Y | −35.74 | Z | 2.60 |
| α | 0.00 | β | 0.00 | γ | 0.00 |

decentration [4]

| | | | | | |
|---|---|---|---|---|---|
| X | 0.00 | Y | −36.55 | Z | 18.09 |
| α | 19.79 | β | 0.00 | γ | 0.00 |

decentration [5]

| | | | | | |
|---|---|---|---|---|---|
| X | 0.00 | Y | −46.50 | Z | 7.00 |
| α | 21.41 | β | 0.00 | γ | 0.00 |

decentration [6]

| | | | | | |
|---|---|---|---|---|---|
| X | 0.00 | Y | −46.50 | Z | 24.00 |
| α | 0.00 | β | 0.00 | γ | 0.00 |

decentration [7]

| | | | | | |
|---|---|---|---|---|---|
| X | 0.00 | Y | 0.00 | Z | 0.00 |
| α | 0.00 | β | 0.00 | γ | 180.00 |

decentration [8]

| | | | | | |
|---|---|---|---|---|---|
| X | 0.00 | Y | 0.00 | Z | 0.00 |
| α | −45.00 | β | 0.00 | γ | 0.00 |

decentration [9]

| | | | | | |
|---|---|---|---|---|---|
| X | 0.00 | Y | 6.00 | Z | 0.00 |
| α | 90.00 | β | 0.00 | γ | 0.00 |

The calculated values for the condition equations (7), (11) to (17) in the examples 1 to 4 explained above are summarized below. As is clear therefrom, examples 1 to 4 all satisfy the equations (7), and (11) to (17). In addition, they also satisfy more narrow ranges of equations (7b) and (11b) to (17b).

| Equation | unit | example 1 | example 2 | example 3 | example 4 |
|---|---|---|---|---|---|
| eq (7) | | 5.59 | 6.30 | 5.92 | 6.50 |
| eq (11) | | 0.69 | 0.70 | 0.73 | 0.62 |
| eq (12) | | 0.95 | 1.14 | 1.03 | 1.03 |
| eq (13) | (°) | 0.50 | 0.37 | 0.57 | 1.47 |
| eq (14) | | 0.38 | 0.26 | 0.24 | 0.39 |
| eq (15) | (mm) | 1.45 | 1.76 | 1.66 | 1.67 |
| eq (16) | (mm) | 3.09 | 2.78 | 2.42 | 2.06 |
| eq (17) | | 0.44 | 0.37 | 0.29 | 0.38 |

According to the decentered optical system of the present invention, in an optical system that focuses the input light of a substantially parallel light beam incident at a field angle on at least one light receiving surface by using a decentered reflecting surface having a rotationally asymmetric free-formed surface, there are the effects that it is possible to prevent light loss due to obstructions or the like before the input light reaches the light receiving surface, the decentered optical system can be made small scale, and furthermore, it is possible to make a high performance decentered optical system in which the light that forms an image on the light receiving surface has a high resolution. In addition, according to the light transmitting device, the light receiving device, and optical system of the present invention, there is the effect that it is possible to construct a light transmitting device, a light receiving device, and an optical system that can carry out high precision and highly efficient light capture and tracking by using the decentered optical system according to the present invention.

Third Embodiment

A light capture and tracking device according to a second embodiment of the present invention will now be explained. The light capture and tracking device consists of a light receiving device part and a light transmitting device part.

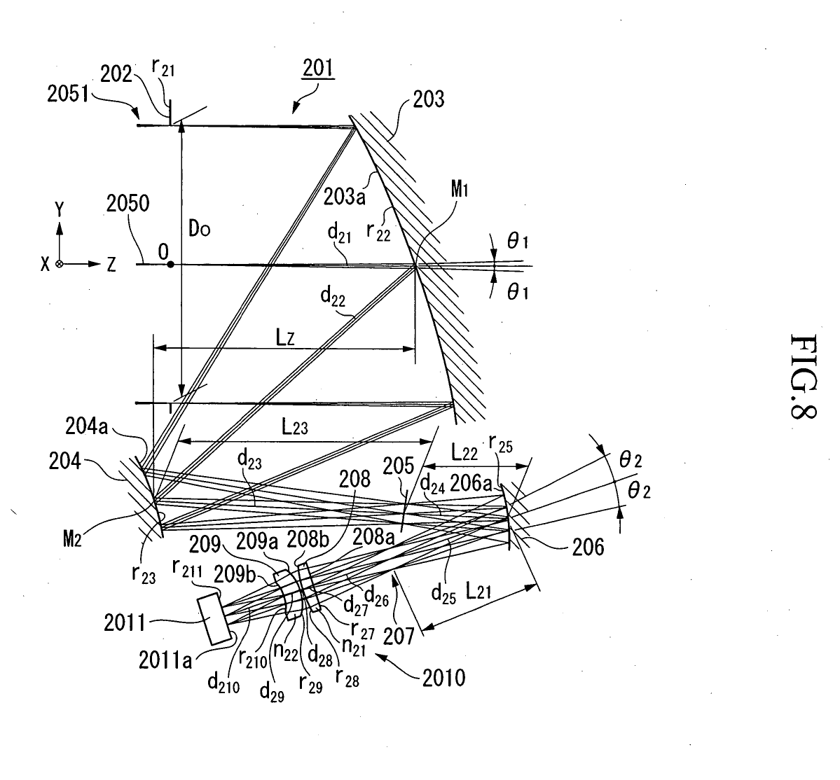

FIG. 8 is a cross-sectional schematic diagram for explaining an example of the schematic structure of the light capture and tracking device according to a third embodiment of the present invention.

The light tracking device 100 (light capture and tracking device) according to the third embodiment of the present invention will now be explained. The light tracking device 100 is a device that transmits and receives substantially parallel input light that can be tracked, and can be advantageously used in the field of optical communication in space.

First, the light receiving device part of the light tracking device 100 will be explained.

The schematic structure of the light receiving device part of the light tracking device 100 consists of the case 43 (device outer packaging), a decentered optical system 40, a control device 41, a deflection control device 56, a movable reflecting element 35, an input signal control device 42, and a gimbal stage 44 (tracking and moving mechanism).

The case 43 is a member that serves both as a supporting member that integrally supports each of the members described below and an outer packaging, and, for example, has an appropriate shape such as a box. In addition, an aperture stop 43a that is an aperture serving as the entrance pupil for the incident light beam 51 is provided on a part of this external packaging. Specifically, when the incident light beam 51 during ordinary use irradiates the case 43, this member is provided as a substantial stop that regulates the diameter of the incident light beam 51, and realizes the aperture stop 2 in the decentered optical system according to the first embodiment.

The aperture stop 43a can be formed by the case 43 and a separate member, and does not necessarily have to be provided in the external surface of the case 43. For example, if the case 43 is shaped such that there is no concern that the incident light beam 51 will be obstructed during normal use, a hood or the like that prevents entrance of flare light can be provided around the aperture stop 43a.

In addition, the aperture stop 43a can be an optical opening, and, for example, can be covered by a cover glass that allows passage of light having a necessary wavelength during focusing.

The decentered optical system 40 can use the decentered optical system according to the first or second embodiment. Here, the aperture stop 43a is fastened by an appropriate support member (not illustrated) on the case 43 at the position of the aperture stop 2 described above.

The decentered optical system 40 will be explained with reference to the example shown in FIG. 8.

Instead of the reflecting mirror 34 in the decentered optical system of the seventh modification of the first embodiment, the decentered optical system 40 similarly provides a condensing lens 34A (focusing device) having a positive power, the beam splitter 64 and the light receiving device 11 provided on the optical path downstream of the splitting are eliminated, beam splitters 52A and 52B (first light path splitting devices) are disposed from the object side between the movable reflecting element 35 and the focusing device 38, and a focusing lens 53A (focusing device), a light receiver 54A and a focusing lens 53B (focusing device), and a light receiver 54B are provided. Below, the part of the configuration that differs from the seventh modification of the first embodiment will be explained in detail.

The beam splitters 52A and 52B are optical elements that each split the light path of a substantially parallel light beam reflected by the movable reflecting element 35. For example, it is possible to use a beam splitter prism having a half mirror coating applied, a half mirror, a polarization beam splitter (PBS) that splits the optical path depending on the polarization properties, an optical element that splits the light beam by wavelength properties, or the like.

The focusing lens 53A (53B) is an optical element for focusing a substantially parallel light beam that has been split by a beam splitter 52A (52B) on a light receiving surface 54a (54b) of a light receiver 54A (54B).

The light receivers 54A and 54B are for detecting the amount of deviation of the incident direction of the incident light beam 51, and it is possible to use a position detecting sensor that can detect the position of image formation such as, for example, a CCD, PSD, a quarter PD. In addition, the position sensitive detectors each have a differing structure. Here, the case will be explained wherein the light receiver 54A carries out position detection over a range that is wider than the light receiver 54B. For example, a configuration can be used wherein the amount of movement of the light beam on the light receiving surface 54a is smaller than the amount of movement on the light receiving surface 54b when the incident field angle changes due to the focal distance and disposition position of the focusing lenses 53A and 53B changing.

In addition, the incident direction detecting devices 55A and 55B that carry out signal processing of the detected signals and calculate the image formation position data for the light beam and the amount of misalignment are connected to the light receivers 54A and 54B. The incident direction detecting devices 55A and 55B convert the results of this calculation to the incident direction of the incident light beam 51, and output a control signal (position signal) for controlling the position of the body 43 so as to conform to the appropriate incident direction.

The incident direction detecting device 55B, which has a high sensitivity to the misalignment of the incident direction, inputs a control signal 104 based on the detected amount into a deflecting control device 56 for controlling the deflection angle of the movable reflecting element 35 via a control device 41. In addition, the deflecting control device 56 is controlled by the control signal 104.

The control device 41 is a device for generating a control signal 102 for appropriately moving the direction of the case 43 based on the control signal that the incident direction detecting devices 55A and 55B output.

The input signal control device 42 is a device that forms an image on the light receiving surface 11a, carries out appropriate signal processing on the electrical signal that has been opto-electrically converted, and sends the input signal 101 outside the device. In particular, for use as alight receiving part in optical communication in space, the configuration provides an optical modulation detecting device for extracting modulated light that includes the data signal from the received light beam.

The gimbal stage 44 is a movement mechanism that supports the case 43 such that its movement can be controlled in two-axis direction, supports the perpendicular rotation drive unit 44a and a horizontal rotation drive unit 44b on a supporting stage 44c, and provides a drive control device 44d for controlling the amount of movement of the perpendicular rotation drive unit 44a and the vertical rotation drive unit 44b.

The horizontal rotation drive unit 44b and the perpendicular rotation drive unit 44a can each rotate around the vertical axis and rotate a predetermined angle around the horizontal axis and can be driven by a mechanism such as a control motor (not illustrated) that can control the angle of rotation of each.

The drive control device 44 is a device for carrying out a predetermined rotational drive by calculating the amount of rotational drive of the perpendicular rotation drive unit 44a and the horizontal rotation drive unit 44b based on a control signal generated by the control device 41.

According to the light receiving device unit of the light tracking device 100 of the present embodiment, if the incident direction of the incident light beam 51 falls within an appropriate range, the incident light beam 51 is incident on the aperture stop 43a. The incident light beam 51 has a light beam diameter that is large in comparison to the aperture stop 43a, and in the range of normal use, the aperture stop 43a is positioned within the light beam diameter even if the incident field angle fluctuates. Thus, the incident light beam 51 that is incident on the aperture stop 43a forms an image at the light receiving surface 11a following the optical path within the decentered optical system 40. In addition, the detected output of the light receiver 11 is sent to the input signal control device 42, and the input signal 101 is transmitted outside the device. Here, in the initial state, the deflection angle of the movable reflecting element 35 is fixed at an initial position. In the initial position, the axial principal ray reaches the center of the light receiving surface 11a.

In addition, the substantially parallel light beam that has been split by the beam splitter 52A (52B) reaches the light receiver 54A (54B) after being focused by the focusing lens 53A (53B). Then the detected output that depends on the light receiving position is sent to the incident direction detecting device 55A (55B).

In contrast, when the optical path of the incident light beam 51 fluctuates or the position of the case 43 is not suitable, that is, when there is an incident field angle with respect to the aperture stop 43a, the positions on the light receiving surface become misaligned.

Thus, the incident direction detecting device 55B calculates the amount of rotation (deflection amount) of the movable reflecting element 35 based on the relationship between the incident direction of the incident light beam 41 that is determined by the optical properties of the decentered optical system 40 and the position at which the light is received on the light receiving surface 54b, and sends the result to the control device 51 and the deflection control device 56 as a control signal 104. Subsequently, tracking is carried out by controlling the movable reflecting element 35. At this time, the amount of movement of the gimbal stage 44 is controlled by the control device 41 such that the incident field angle falls into a range that can be detected by the incident direction detecting device 55B.

In addition, the incident direction detecting device 55A calculates the amount of movement of the case 43 based on the relationship between the incident direction of the light beam 41 from the optical properties of the decentered optical system 40 and the position at which the light is received on the light receiving surface 54a, and sends the result to the drive control device 44d and the control device 41 as a control signal 102. The incident direction detecting device 55A notifies the control device 41 when a certain region of the detected range is exceeded. The incident direction detecting device 55A has a wide detecting range, and it is always possible to carry out position detection by controlling the gimbal stage 44 using the signal from the incident direction detecting device 55A.

The control device 41 receives the control signals from the incident direction detecting devices 55A and 55B, and sends a control signal 102 to the drive control device 44d. The control signal 102 determines the target position for the movement of the case 43. The movement target position is set such that the optical axis of the incident light beam 51 and the incident optical axis of the decentered optical system 40 agree within a predetermined range.

In this case, if the gimbal stage 44 can carry out high precision movement, the amount of movement can be controlled based on the high resolution position information from the incident direction detecting device 55B. However, in order to move rapidly, it is possible to generate a control signal 102 causing movement up to an approximate target position based on position information having a range that is more wide than the incident direction detecting device 55A. The approximate target position is the correct target value as long as at least the detecting output is generated at the light receiver 54B.

When it has moved up to the approximate target value, the gimbal stage 44 is stopped and the position maintained. Then, the movable reflecting element 35 is rotated based on a control signal sent from the control device 41 to the deflection control device 56, and deflection angle control is carried out such that the light receiving position on the light receiving surface 11a maintains a constant position. However, in the case that the incident angle of the incident light keeps changing continuously, by linking the gimbal stage 44 and the movable reflecting element 35, control is carried out so as to always maintain a condition in which optimal light reception is attained.

For example, in the field of optical communication, the surface area of the light receiving surface 11a have become extremely small as communication speeds have become faster. In particular, in the case that the light receiving surface 11a is the end of an optical fiber, it is necessary that a light beam having a minute spot diameter be coupled with the light receiving surface of a core having an extremely small diameter that is equal to or less than 10 μm.

In the case that such fine movement control is carried out using only the gimbal stage 44, an extremely high precision is required. In this case, preferably high precision tracking is carried out at the movable reflecting element 35 (galvano-mirror).

Next, the light transmitting device unit of the light capture and tracking device according to the second embodiment will be explained.

The light transmitting device unit of the light tracking device 100 provides a light transmitting capacity by providing a light source 70, an output signal control device 63 and a half mirror 60 (optical path merging device).

The light source 70 provides a semiconductor laser 62 and a collimator lens 61 for making the divergent light beam of the semiconductor laser 62 into parallel output light.

The output signal control device 63 is a device for carrying out drive control of the semiconductor laser 62 depending on the output signal 103 carried by the transmitted light beam.

The half mirror 60 is disposed along the optical path between the movable reflecting element 35 and the beam splitter 52A, the light beam incident from the object direction in the optical path thereof is partially transmitted, and the optical axis of the output light emitted from the light source is reflected towards the object side. For example, the half mirror 60 can use an optical element that can be suitably used in the beam splitter 52A in the same manner.

The light transmitting device unit of the light tracking device 100 adjusts the disposition position of the light source 70 with respect to the half mirror 60, and the optical axis of the output light emitted by the light source 70 is made to align with the axial principal ray between the movable reflecting element 35 and the beam splitter 52A. As a result, the output light moves backwards along the optical path of the decentered optical system 40, reaches the movable reflecting element 35, the lens 34A, the reflecting mirror 33, and the reflecting mirror 32, is reflected by the reflecting mirror 32 and is emitted outside the case 43.

At this time, the deflection angle of the movable reflecting element 35 is controlled such that the incident light beam 51 forms an image at a predetermined position on the light receiving surface 11a, and thus it is always possible to emit the output light towards the correct direction in a fixed state without varying the position of the light source 70 in order to control the direction of emission of the output light. Specifically, a light transmitting capacity is provided wherein the output light is emitted outside the device after passing backwards through the optical path that the input light passes through.

In this manner, in the light receiving device unit of the light tracking device 100, even if the input field angle fluctuates, the light receiving device can carry out the capture and tracking of the light, and it is possible to carry out stable light reception with little fluctuation in the amount of received light. In addition, the coarse movement is carried out by the gimbal stage 44 and the fine movement control necessary for higher speed control is carried out by using the movable reflecting element 35 to control the deflection angle of the light beam. Thus, for example, a light capture and tracking device is possible that is extremely suitable when high precision and high-speed response, as in optical communication in space, is required.

In the light transmitting device unit of the light tracking device 100, the essential components of the decentered optical system 400 are used for several purposes during optical transmission, and thus there are the advantages that it is possible to form a device having a small number of components and it is possible to make a compact device. In addition, because it is possible to emit output light reliably simply by capturing and tracking the input light, there is the advantage that an inexpensive device can be made.

Therefore, according to the light tracking device 100 of the present invention, the operation and effect of the decentered optical system of the first embodiment can be provided, and at the same time, it is possible to make a light capture and tracking device that can carry out stable light transmission and reception by carrying out high precision and high efficiency light capture and tracking of the input light.

Note that if two light capture and tracking devices are disposed separated from and opposite to each other, the structure has both a light transmitting device unit and a light receiving device unit together and can capture and track light. Thus, an optical system for optical communication in space becomes possible that carries out stable bi-directional light transmission and reception even when the relative positions fluctuate by carrying out tracking.

In addition, the light transmitting device can eliminate one dedicated light receiving device unit outside the decentered optical system of the light receiving device unit, and is formed by an output signal control device, a light source that emits a substantially parallel light beam, and a decentered optical system. In addition, a light receiving device that can capture and track light can eliminate the one of the other light transmitting device units outside the decentered optical system that are disposed at a separated and opposite position. The light receiving device is formed by a decentered optical system 40, a movable reflecting element 35, focusing devices 53A and 53B, light receivers 54A and 54B, incident direction detecting devices 55A and 55B, control device 41, and deflection control device 56. Thereby, an optical system for unidirectional space communication becomes possible that carries out light capture and tracking.

Furthermore, if a beacon light is made that carries a light that has not been signal modulated by an output signal control device of a light transmitting device and the light receiving device 11 and the input signal control device 42 of the light receiving device are eliminated, an optical system for light capture and tracking that is not limited to space communication becomes possible.

In addition, in an optical system for bi-directional or unidirectional space communication, if the optical axis of the decentered optical system and the aligned decentered optical system are disposed in separate optical systems on the light transmitting side and the light receiving side and the signal beam for the optical communication in space is transmitted and received, an optical system for optical communication in space that has separate optical systems for tracking and light transmission and reception becomes possible.

In addition, a light receiving device that can capture and track light can eliminate the one of the other light transmitting device units outside the decentered optical system that are disposed at a separated and opposite position. In addition, in the case that there is no relative position change, for example, between buildings, by eliminating items related to the tracking in the light receiving device (unit), an optical system for bi-directional or unidirectional optical communication in space providing a fixed decentered optical system becomes possible.

In addition, in the explanation of the third embodiment, an example was explained wherein the decentered optical system 40 was formed by the decentered optical system of the seventh modification of the first embodiment, but the decentered optical system 40 is not limited by the seventh modification.

The decentered optical systems of the first embodiment all have an entrance pupil, and has a substantially parallel light beam between the exit pupil and the focusing device, and thus, in any case, because the optical path length between the exit pupil and the focusing device can be freely determined, disposing the optical path splitting device and the optical path merging device is easy.

In addition, in the explanation of the third embodiment, an example was explained wherein the output of the light receiving surface used in the incident direction detecting devices uses the detected output of the light receiving surface on the optical path divided by the first optical splitting device, but the detected output of another image plane of an intermediate image formed after the optical path has been split by the second optical path splitting device can be used as the light receiving surface.

In addition, in the explanation of the third embodiment, an example was explained wherein the optical path merging device is provided between the rotatable reflecting surface and the first optical path splitting device, but the optical path merging device can be disposed anywhere if it is farther on the image side than the exit pupil.

For example, the optical path merging device can be disposed on the image side between the optical path splitting devices.

In addition, for example, the optical path merging device can be disposed on the image side of the focusing device. In this case, in the light source, the optical element of the focusing device can also act as the optical element for making a light beam parallel.

In addition, in the explanation of the third embodiment, an example was explained wherein the decentered optical system was accommodated in an external device and was moved by a tracking and movement mechanism in the external device. However, it is possible to have only the decentered optical system track and move. Therefore, the aperture stop 43a is not provided in the external device, an optical unit that holds the decentered optical system is provided inside the external device, and this optical unit can be moved by a tracking and movement mechanism. At this time, except for the incident direction detecting devices and the decentered optical system such as the rotation control device can be provided outside the optical unit. Thus, because the inertia that moves the tracking and movement mechanism is reduced, it is possible to carry out faster light capture and tracking.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A decentered optical system in which a substantially parallel light beam is used as the input light, comprising:
a first optical element having positive power, a second optical element having a rotationally asymmetric decentered reflecting surface that is disposed decentered from and tilted on the optical axis of the input light, and at least one a third optical element formed by an optically active surface having a positive power in order along the optical path of the input light; and further,
an intermediate image is formed by these first and second elements and an exit pupil is formed by the first through third optical elements; and
a focusing device that focuses the light beam that has passed through the exit pupil onto at least one light receiving plane, whereby a principal ray and a subsidiary ray of the axial light beam incident on the exit pupil is almost parallel.

2. A decentered optical system according to claim 1, wherein:
when the angle formed between the principal ray and the subsidiary ray of the axial light beam incident on the exit pupil is denoted by θ, the following equation is satisfied:
−6°≦θ≦8°

3. A decentered optical system according to claim 1, wherein:
the entrance pupil diameter D, the incident field angle ω₁ of the input light towards the entrance pupil, and the incident field angle ω₂ of the principal ray when the input light is incident on the entrance pupil, satisfy the following equation:
0.5 (mm)≦D·(ω₁/ω₂)≦15 (mm)

4. A decentered optical system according to claim 1, wherein:
the distance L₁ along the optical axis from the optically active surface of the third optical element nearest the image side to the position of the exit pupil, and the entrance pupil diameter D, satisfy the following equation:
0.05≦(L₁/D)≦3

5. A decentered optical system according to claim 1, wherein:
the distance L₂ along the optical axis from the position where the intermediate image is formed to the optically active surface of the third optical element nearest to the object side, and the entrance pupil diameter D, satisfy the following equation:
0.03≦(L₂/D)≦1.5

6. A decentered optical system according to claim 1, wherein:
the distance L₃ along the optical axis from the decentered reflecting surface of the second optical element to the position where the intermediate image is formed, and the entrance pupil diameter D, satisfy the following equation:
0.3≦(L₃/D)≦3

7. A decentered optical system according to claim 1, wherein:
the paraxial composite focal distance f₁ between the first optical element and the second optical element and the paraxial focal distance f₂ of the third optical element satisfy the following equation:
4≦(f₁/f₂)≦60

8. A decentered optical system according to claim 1, wherein:
a rotatable reflecting surface is disposed on the optical path in proximity to the exit pupil.

9. A decentered optical system according to claim 8, wherein:
the rotatable reflecting surface is formed by a galvano-mirror.

10. A decentered optical system according to claim 1, wherein:
at least one first optical path splitting device is disposed on the image side of the exit pupil; and
light receiving surfaces are disposed at optical paths that have been split at the first optical splitting device.

11. A decentered optical system according to claim 1, wherein:
a second optical path splitting device that splits the optical path is provided on the optical path between the decentered reflecting surface of the second optical element and the optically active surface of the third optical element, this optically active surface having a positive power.

12. A decentered optical system according to claim 11, wherein:
another intermediate image is formed on the optical path that has been split by providing the second optical path splitting device on the object side at the position where the intermediate image is formed; and
an intermediate image light receiving surface is disposed at the position of the image plane of the other intermediate image.

13. A decentered optical system having a substantially parallel light beam as an input light, wherein:
a first, second, and third optical element respectively having a positive power, a negative power, and a positive power are disposed in order along the optical path of the input light, and a decentered reflecting surface having a rotationally asymmetric surface disposed decentered from the optical axis of the input light is provided on the first and second optical element;
a substantially afocal optical system in which an intermediate image is formed on the optical path of the first through third optical elements and an exit pupil is formed on the image side of the third optical element;
a focusing device in which a substantially parallel light beam emitted from the exit pupil forms an image on the light receiving surface is provided on the optical path on the image side of the exit pupil; and
when the plane that includes the input light and the axial principal rays of the light beam reflected by the first and second optical elements serves as the Y-Z plane, the direction in which the axial principal ray progresses from the object side to the reflecting surface of the first optical element serves as the Z-axis, the direction perpendicular to the Z-axis in the Y-Z plane serves as the Y-axis, and the direction perpendicular to the Y-Z plane serves as the X-axis, then the maximum field angle θ_{oy} in the Y direction on the object side, the maximum field angle θ_{ey} in the Y direction in the exit pupil, the image height h of the intermediate image, and the diameter of the entrance pupil D₀ satisfy the following formula:
1.5<[{(θ_{ey}/θ_{oy})+2}×(h/tan θ_{ey})]/D₀<10

14. A decentered optical system according to claim 13, wherein, when the points at which an axial principal ray is reflected by the respective decentered reflecting surfaces of the first and second optical elements are denoted by point M₁ and point M₂, the Z direction component L_{z} of the distance between the point M₁ and the point M₂, and the effective diameters D₁ and D₂ of their respective decentered reflecting surfaces satisfy the following equation:
0.35<{(D₁+D₂)/2}/L_{z}<2.0

15. A decentered optical system according to claim 13, wherein the Y direction incident maximum field angle θ_{my} from the object side and the focal distance F_{oy} in the Y direction of the objective optical system in the substantially afocal optical system that consists of the first and second optical elements satisfy the following equation:
0.5 (mm)<F_{oy}·tan θ_{my}<4.0 (mm)

16. A decentered optical system according to claim 13, wherein:
when the angle between a principal ray and a characteristic ray of the axial light beam incident on the exit pupil is denoted θ, the following equation is satisfied:
−3≦θ≦4°

17. A decentered optical system according to claim 13, wherein:
the entrance pupil diameter D₀, the incident field angle θ₁ of the input light towards the entrance pupil, and the incident field angle θ₂ of a principal ray when the input light is incident on the exit pupil satisfy the following equation:
0.2 (mm)≦D₀·(θ₁/θ₂)≦40 (mm)

18. A decentered optical system according to claim 13, wherein:
the distance L₁ along an axial principal ray from the optically active surface closest to the image side of the third optical element to the position of the exit pupil, and the entrance pupil diameter D₀ satisfy the following equation:
0.01≦(L₁/D₀)≦0.7

19. A decentered optical system according to claim 13, wherein:
the intermediate image is positioned between the decentered reflecting surface of the second optical element and the third optical element.

20. A decentered optical system according to claim 13, wherein:
the distance L₂ along an axial principal ray from the position where the intermediate image is formed to optically active surface closest to the object side of the third optical element, and the entrance pupil diameter Do satisfy the following equation:
0.015≦(L₂/D₀)≦0.7

21. A decentered optical system according to claim 13, wherein:
the distance L₃ along an axial principal ray from the decentered reflecting surface of the second optical element to the position at which the intermediate image is formed, and the entrance pupil diameter D₀ satisfy the following equation:
0.1≦(L₃/D₀)≦10

22. A decentered optical system according to claim 13, wherein:
a rotatable reflecting surface is disposed on the optical path in proximity to the exit pupil.

23. A decentered optical system according to claim 22, wherein:
the rotatable reflecting surface is formed by a galvano-mirror.

24. A decentered optical system according to claim 13, wherein:
the decentered reflecting surface of the first optical element consists of a free-formed surface that has only one plane of symmetry.

25. A decentered optical system according to claim 13, wherein:
the decentered reflecting surface of the second optical element consists of a free-formed surface having only one plane of symmetry.

26. A decentered optical system according to claim 13, wherein:
the third optical element provides an optically active surface that consists of a rotationally asymmetric surface.

27. A decentered optical system according to claim 13, wherein:
the third optical element provides an optically active surface that consists of a free-formed surface that has only one plane of symmetry.

28. A light transmitting device comprising the decentered optical system according to any one of claims 127 claim 1 and a light source that emits a substantially parallel light beam.

29. A light receiving device according to claim 28, comprising:
a light beam merging device for making the substantially parallel light beam emitted from the light source incident on the exit pupil is provided.

30. A light receiving device comprising the decentered optical system according to claim 1, wherein at least one of the light receiving surfaces is formed by a position detecting sensor.

31. A light receiving device comprising a decentered optical system according to claim 1, a light receiver provided on the light receiving surface of the decentered optical system, and an input signal control device that is connected to the light receiver.

32. An optical system an optical system that includes an optical transmitting device that emits a substantially parallel light beam, and an optical receiving device that is disposed separated from and opposed to the optical transmitting device and receives the substantially parallel light beam as input light, wherein:
the light receiving device provides the decentered optical system according to claim 1.

33. An optical system according to claim 32, wherein:
at least one of the light receiving surfaces of the light receiving device is formed by a position detecting sensor, and light capture and tracking are carried out based on the position signal from the position detecting sensor.

34. An optical system according to claim 32, wherein:
the light transmitting device has an output signal control device, light receiving device has an input signal control device, the communication signal is received and transmitted after modulation, and thereby optical communication in space can be carried out.
